(19) United States
(12) Patent Application Publication
(10) Pub. No.: US 2020/0191272 A1
(43) Pub. Date: Jun. 18, 2020

(54) CYLINDER HEAD GASKET

(71) Applicant: ElringKlinger AG, Dettingen (DE)

(72) Inventor: Thomas Schumacher, Riederich (DE)

(21) Appl. No.: 16/796,165

(22) Filed: Feb. 20, 2020

Related U.S. Application Data
(63) Continuation of application No. PCT/EP2018/072644, filed on Aug. 22, 2018.

(30) Foreign Application Priority Data
Aug. 23, 2017 (DE) 10 2017 119 307.3

(51) Int. Cl. F16J 15/08; F02F 11/00

(52) U.S. Cl. CPC F16J 15/0818; F16J 15/0887; F02F 11/002

(57) ABSTRACT

A cylinder-head gasket with a metal sealing layer (10) in which there are provided at least one combustion-chamber opening (B), screw holes around said opening for cylinder-head screws, and a combustion-chamber sealing bead (16) stamped into the sealing layer, wherein the combustion-chamber sealing bead has, on its convex side, a crest portion (30a′) which lies between two bead legs (32a′), by means of which bead legs the crest portion is connected to the sealing layer, and wherein the combustion-chamber sealing bead has screw portions, each of which lies closest to a screw hole, and has intermediate portions between the screw portions; in order to improve the sealing capability of the cylinder-head seal, the deformation resistance of the bead legs with respect to pressing forces is greater, at least in longitudinal regions of the intermediate portions, than in screw portions of the combustion-chamber sealing bead.

### CROSS-REFERENCE TO RELATED APPLICATIONS

This application is continuation of International Application No. PCT/EP2018/072644, filed on Aug. 22, 2018, which claims priority to German Application No. 10 2017 119 307.3, filed on Aug. 23, 2017, which applications are hereby incorporated in their entirety by reference in this application.

### FIELD OF DISCLOSURE

The invention relates to a cylinder-head gasket with a metal sealing layer in which there are provided at least one combustion-chamber opening (associated with a cylinder of a reciprocating internal combustion engine) and screw holes around said opening for the passage of cylinder-head screws, and a combustion-chamber sealing bead stamped into the sealing layer; the combustion-chamber sealing bead has, on its convex side, a crest portion which extends in the bead longitudinal direction and is arranged, along the combustion-chamber sealing bead, in a plan view of the sealing layer between two bead legs, or, in a cross-section through the bead, above or below two bead legs, by means of which bead legs the crest portion is connected to regions of the sealing layer bordering the combustion-chamber sealing bead, into which regions the bead legs transition in each case by a bead foot; in a plan view of the sealing layer the screw holes are arranged at a spacing from the combustion-chamber opening and at spacings from one another in the peripheral direction of the combustion-chamber opening and the combustion-chamber sealing bead runs between the combustion-chamber opening and the screw holes; the combustion-chamber sealing bead has screw portions, each of which lies closest to a screw hole, and intermediate portions between these screw portions.

In particular, the invention relates to a cylinder-head gasket of this kind having a single sealing layer.

### BACKGROUND

A person skilled in the art is familiar with cylinder-head gaskets of this kind from the prior art.

As is also the case with known metal cylinder-head gaskets, the sealing layer of a cylinder-head gasket pertaining to the present invention may also be provided on one or both sides fully or partially with a coating of a non-metal or metal material, and therefore the sealing layer of the above-defined cylinder-head gasket does not have to be made purely of metal.

In particular, the invention relates to a cylinder-head gasket of the kind defined at the outset, which is a cylinder-head gasket for a multi-cylinder engine, more specifically for a multi-cylinder commercial vehicle engine. Lastly, it should also be noted that the invention relates above all to cylinder-head gaskets for diesel engines.

A cylinder-head gasket is always clamped between an engine block (also referred to as a crankcase) and a cylinder head of a reciprocating internal combustion engine, more specifically with the aid of cylinder-head screws, which pass through bores in the cylinder head and screw holes in the cylinder-head gasket and extend into bores in the engine block which are provided with threads. Since the clamping forces acting on the cylinder-head gasket consequently are introduced by the cylinder-head screws more or less at specific points into the sealing assembly comprising the cylinder head, the cylinder-head gasket and the engine block, and since the engine components constituted by the cylinder head and engine block do not form absolutely rigid components, the latter and the cylinder-head gasket are pressed en bloc in the regions of the cylinder-head screws, such that the sealing gap to be sealed there by the cylinder-head gasket and accommodating the cylinder-head gasket has its shortest height or smallest width between mutually opposed sealing faces of the two aforementioned engine components, however, since the height or width of the sealing gap becomes larger with increasing spacing (as seen in a plan view of the engine) from the cylinder-head screws on account of the fact that the engine components are not absolutely rigid and due to the reaction forces of the clamped cylinder-head seal, the pressing forces acting on the cylinder-head gasket decrease with increasing spacing from the cylinder screws; consequently, the sealing forces which are generated by a combustion-chamber sealing bead of constant geometry over its periphery, and which are effective between the combustion-chamber sealing bead and those regions of the sealing faces of the two aforementioned engine components between which the combustion-chamber sealing bead is clamped also decrease.

Under consideration of this fact, specifically that without special amounts in a cylinder-head gasket of the kind described at the outset the pressing forces acting on the combustion-chamber sealing bead of the installed cylinder-head gasket decrease in the intermediate portions of the combustion-chamber sealing bead with increasing spacing from the cylinder-head screws or screw holes, it is already known from the prior art, in order to equalize the sealing pressure generated by the combustion-chamber sealing bead of the installed cylinder-head seal, to provide the combustion-chamber sealing bead, at least in its aforementioned intermediate portions along the combustion-chamber sealing bead, with a height and/or width profile, more specifically in such a way that the rigidity, that is to say the deformation resistance of the combustion-chamber sealing bead to pressing forces oriented perpendicularly to the cylinder-head seal, varies in these intermediate portions. In this regard it should be noted that with a constant material thickness along the bead and over the bead cross-section and with constant material properties, the rigidity of a bead produced in a metal sealing layer of a cylinder-head gasket increases with increasing bead height with constant bead width (measured in a plan view of the sealing layer) along the bead, and decreases with increasing bead width with constant bead height along the bead.

With regard to the prior art, reference is made to DE 41 42 600 A1 in the name of Elring Dichtungswerke GmbH, which discloses a cylinder-head gasket with a metal sealing plate, in which an annular metal combustion-chamber sealing element with screw portions and intermediate portions arranged successively in alternation along the sealing element is inserted around a combustion-chamber opening; the sealing pressure generated by the installed cylinder-head gasket is equalized in that the intermediate portions of the combustion chamber sealing element, at least over part of their length, have a greater radial width and/or a greater height or thickness and/or a greater hardness than the screw portions. With regard to the hardness, DE 41 42 600 A1 merely discloses that the (entire) combustion-chamber sealing element has such a hardness profile along its periphery that, when the cylinder-head gasket is installed, an approximately constant sealing pressure is provided along the periphery of the combustion-chamber sealing element, more specifically on account of material properties, such as microstructural conditions, of the metal combustion-chamber sealing element that differ accordingly in different regions, for example as a result of the heat treatment of longitudinal portions of the combustion-chamber sealing element (nothing else can be inferred from the last paragraph of column 4 of DE 41 42 600 A1). In one embodiment of this known cylinder-head gasket the annular combustion-chamber sealing element is provided with a bead extending in its peripheral direction, with regard to which it is noted that the combustion-chamber sealing element is more deformable in the region of this bead than in a bead-free region (see column 7, lines 7 to 19).

In many engine constructions with a cylinder-head gasket of the kind mentioned at the outset, the installation space available for accommodating the combustion-chamber sealing bead is limited at least in some regions along this bead, more specifically above all with regard to the width of the combustion-chamber sealing bead. As is usual, also in the case of a cylinder-head gasket pertaining to the present invention, the combustion-chamber sealing bead is formed as what is known as a full bead with a bead crest (crest portion) and two bead legs, such that the cross-section of the combustion-chamber sealing bead is approximately rectangular or corresponds approximately to a trapezoid or approximately a U, wherein with all of these cross-sectional forms the transitions of the bead crest into the bead legs and the transitions, formed by the bead legs, of the bead feet into the regions of the sealing layer bordering the bead feet are preferably rounded. Thereby, when the cylinder-head gasket is installed, the combustion-chamber sealing bead can produce a sufficient sealing of the combustion-chamber gases all over along the bead, it is necessary for the bead crest and the bead feet to be acted on all over by pressing forces sufficient for a sufficient gas seal; this presupposes that, if the cylinder-head seal, at relatively short radial spacings from a combustion-chamber opening, has other openings such as a further combustion-chamber opening or one or more openings for the passage of cooling water or engine oil, at least there the width of the bead crest and/or the width of the sealing bead measured at the bead feet (in each case measured in a plan view of the cylinder-head seal) must be much smaller than the radial spacing of the edge of the combustion-chamber opening from each of these other openings. A limitation of the installation space available for accommodating the combustion-chamber sealing bead and a corresponding limitation of the bead width, however, is also provided if at least one of the engine components constituted by the cylinder head and engine block has a sealing face region in its component sealing face in the vicinity of an engine cylinder, in which sealing face region the component rigidity of this component is much lower in respect of pressing forces directed perpendicularly to its component sealing face than in sealing face regions of this component adjacent to this sealing face region, in particular on account of a cavity provided in this engine component, for example for cooling water or engine oil.

### SUMMARY OF THE INVENTION

The object of the invention was now to develop a cylinder-head gasket of the kind described at the outset, which can be mass produced reliably and relatively easily and the combustion-chamber sealing bead of which is able to generate all over, with its bead crest and its bead feet, pressing forces that are sufficiently high for sealing off the combustion-chamber gases, more specifically also at those points of the sealing assembly comprising an engine block, a cylinder head and the cylinder-head gasket where there is not the installation space necessary to be able to use a combustion-chamber sealing bead having a width profile (that is to say a combustion-chamber sealing bead of which the width as measured at the bead crest and/or at the bead feet varies along the combustion-chamber sealing bead) of which the width changes are sufficiently great to be able to compensate for larger local changes to the component rigidity of the engine block and/or of the cylinder head.

In a cylinder-head gasket of the kind defined at the outset, this problem can be solved in accordance with the invention with a combustion-chamber sealing bead in which the deformation resistance of the bead legs of the combustion-chamber sealing bead with respect to pressing forces oriented perpendicularly to the sealing layer and acting on the combustion-chamber sealing bead is greater at least in longitudinal regions of the intermediate portions of the combustion-chamber sealing bead than in screw portions of the combustion-chamber sealing bead.

At points of the above-mentioned sealing assembly at which, with use of a combustion-chamber sealing bead with uniform geometry and/or bead rigidity (uniform deformation resistance) along the bead, the combustion-chamber sealing bead is not acted on by pressing forces sufficient for sufficient gas sealing, in a cylinder-head gasket according to the invention the deformation resistance of the bead legs of the combustion-chamber sealing bead is such that, when the cylinder-head gasket is in the installed state, the combustion-chamber sealing bead of the cylinder-head seal, above all also the intermediate portions thereof, is acted on by pressing forces which, along the periphery of the sealing bead, are sufficient all over for reliable gas sealing.

Since, as has already been mentioned above, the clamping forces acting on the installed cylinder-head gasket are introduced through the cylinder-head screws more or less at specific points into the sealing assembly comprising the cylinder head, the cylinder-head gasket and the engine block, and the cylinder head as well as the engine block do not form absolutely rigid components, it is ensured by the cylinder-head screws that the cylinder-head seal, in the regions of the cylinder-head screws, is pressed against the mutually opposed sealing faces of the engine block and of the cylinder head with forces sufficient to attain the desired sealing effect; since, however, on account of the fact that the engine block and cylinder head are not absolutely rigid and due to the reaction forces of the clamped cylinder-head seal, the height or width of the sealing gap to be sealed by the cylinder-head seal, between the mutually opposed sealing faces of the engine block and cylinder head, in regions of the aforementioned sealing assembly which, in a plan view of these sealing faces and the cylinder-head seal, lie between mutually adjacent cylinder-head screws (or between mutually adjacent screw holes in the cylinder-head seal), is greater, at least in some regions, than at the cylinder-head screws (or screw holes), in preferred embodiments of the cylinder-head gasket according to the invention the combustion-chamber sealing bead and at least one of its intermediate portions, at least in a longitudinal region of such an intermediate portion, has a height profile, more specifically in such a way that the size of the protrusion of the convex side of the combustion chamber sealing bead beyond the regions of the directly adjacent sealing layer varies along this intermediate portion of the combustion-chamber sealing bead. Such a height profile is recommended for the case that the at least predominantly resilient flexibility of the cylinder head and/or of the engine block between the cylinder-head screws cannot be compensated for solely by the fact that the deformation resistance of the bead legs of the combustion-chamber sealing bead is greater, at least in longitudinal regions of the intermediate portions of the combustion-chamber sealing bead, than in the screw portions thereof; the aforementioned flexibility of the components constituted by the cylinder head and engine block, which fundamentally are not absolutely rigid, may be even greater locally if the cylinder head and/or the engine block also has other openings in its sealing face facing the cylinder-head gasket at relatively short radial spacings from a cylinder chamber, and/or the cylinder head or the engine block has a cavity, for example for cooling water, close to a cylinder chamber.

The invention relates above all to cylinder-head gaskets of which the combustion chamber sealing bead is formed as what is known as a rectangular bead or trapezoidal bead—the cross-sections through the combustion-chamber sealing bead (sections in planes running perpendicularly to the longitudinal direction or peripheral direction of the combustion-chamber sealing bead) have the cross-sectional form of a sealing layer region provided with a groove formed therein and an oppositely arranged protrusion, wherein, on the concave side of the combustion-chamber sealing bead, the groove base runs substantially parallel to the plane of the actual sealing layer, and the groove side walls in the case of a rectangular bead run substantially perpendicularly and in the case of a trapezoidal bead run substantially obliquely to this sealing layer plane, however, the transitions of the groove side walls into the actual sealing layer and into the groove base are not strictly rectangular in cross-section, but instead are rounded.

The invention relates primarily to cylinder-head gaskets having a sealing layer, preferably a single sealing layer, with a metal sheet made of a cold-formable steel being used for their production. Such a steel is more deformable than a spring steel (see in particular the comments provided below with regard to spring steels), and the hardness or compressive strength of a cold-formable steel of this kind can be increased locally by stamping or impact extrusion—in the event of such a forming procedure, the metal of the sealing layer is made to flow in some regions, whereby cold-forming involves a strain hardening of the metal of the formed sealing layer regions.

In the case of a cylinder-head gasket according to the invention, the deformation resistance or the rigidity of the combustion-chamber sealing bead, at least in longitudinal regions of its intermediate portions, is increased at least primarily or predominantly in that the deformation resistance or the rigidity of the bead legs is increased in these longitudinal regions. The deformation resistance of the bead legs in respect of pressing forces oriented perpendicularly to the sealing layer and acting on the crest portion of the combustion-chamber sealing bead is in particular at least more than 50% greater, preferably more than 60% greater, and in particular more than 70% greater, at least in longitudinal regions of the intermediate portions of the combustion chamber sealing bead than in screw portions of the combustion-chamber sealing bead.

The deformation resistance of the combustion-chamber sealing bead in intermediate portions thereof may also be increased, at least in longitudinal regions of the intermediate portions, in that the crest portion of the combustion-chamber sealing bead is changed appropriately there (compared with other longitudinal regions of the combustion-chamber sealing bead); as already mentioned, however, the increase, in some regions, of the deformation resistance of the combustion-chamber sealing bead is achieved in accordance with the invention at least primarily or predominantly by an increase, in some regions, of the deformation resistance of the bead legs.

The solution according to the invention is based on the consideration that, in the case of a combustion-chamber sealing bead with varying bead rigidity or varying deformation resistance along the bead, changes to the bead rigidity may be brought about above all by a locally differing rigidity or a locally differing deformation resistance of the bead legs of the combustion-chamber sealing bead. With a combustion-chamber sealing bead in which the bead legs have a varying deformation resistance along the bead, the rigidity or the deformation resistance of the combustion-chamber sealing bead can also be adapted, along the latter, in some regions or locally, to the locally different component rigidities of the engine components constituted by the cylinder head and engine block, without the width of the combustion-chamber sealing bead (in a plan view of the latter) having to be varied; this is also true for the case in which the width of the combustion-chamber sealing bead on the side of its bead feet, that is to say on its concave side, is larger than on its convex side, that is to say in the region of its bead crest or crest portion (in each case in a plan view of the cylinder-head seal).

Preferred embodiments of the cylinder-head gasket according to the invention are characterized by at least one of the following features:
(a) the cylinder-head gasket has just a single metal sealing layer, particularly if it is a cylinder-head gasket for a multi-cylinder commercial vehicle engine;
(b) the sealing layer configured in accordance with the invention is made from a sheet steel where the steel is not spring steel—in the case of a spring steel the ratio of the yield strength Re or alternatively the proof stress R_{p0.2} to the tensile strength Rₘ of the steel is greater than 0.85;
(c) the cylinder-head gasket is configured for a multi-cylinder liner engine, that is to say for an engine in which the engine block or crankcase has a cylinder liner for each cylinder.

Advantageous embodiments of the cylinder-head gasket according to the invention are characterized in that, in intermediate portions along the combustion-chamber sealing bead, at least in longitudinal regions of the intermediate portions,
(a) the cross-section of the bead legs in respect of their cross-sectional shape and/or cross-sectional area
and/or
(b) the hardness or compressive strength of the metal of the bead legs, averaged over the cross-section of the bead legs,

varies such that, in these longitudinal regions of the intermediate portions, the deformation resistance of the combustion-chamber sealing bead measured in the direction of the screw hole axes differs locally along the combustion-chamber sealing bead, that is to say varies along the combustion-chamber sealing bead (not necessarily all over).

In the case of a cylinder-head gasket according to the invention it is preferred if, along the combustion-chamber sealing bead in zones of the bead legs delimited by planes running parallel to the plane of the sealing layer, at least in longitudinal regions of the intermediate portions, the material thickness and/or the structure of the metal of the bead legs varies along the aforementioned longitudinal regions such that, along the combustion-chamber sealing bead in these longitudinal regions of the intermediate portions, the deformation resistance of the combustion-chamber sealing bead measured in the direction of the screw hole axes is different locally along the combustion-chamber sealing bead.

Advantageous embodiments of the cylinder-head gasket according to the invention are also those which are configured such that, along the combustion-chamber sealing bead, the cross-section of said bead and/or the structure of the metal of the sealing layer varies, in particular primarily or predominantly in the bead legs, in such a way that when the cylinder-head gasket is installed and pressed between the engine components constituted by the cylinder head and engine block, the crest portion of the combustion-chamber sealing bead is acted on all over, in the intermediate portions of said bead, by pressing forces sufficient to provide an adequate sealing of combustion-chamber gases. Here, the combustion-chamber sealing bead may be configured such that a variation in its cross-section also results in a variation of its cross-sectional area. A variation of the cross-section and/or of the metal structure shall be understood here to mean that the cross-sectional form and/or the structure changes along the combustion-chamber sealing bead, wherein cross-sectional changes shall be understood to mean changes which result in a change to the deformation resistance of the combustion-chamber sealing bead, in particular primarily or predominantly or even exclusively of the bead legs.

In a cylinder-head gasket according to the invention, particularly preferred embodiments are those in which, along the combustion-chamber sealing bead, the cross-sectional form of said bead and/or the structure of the metal of the sealing layer varies at least substantially or predominantly in the two bead legs, which does not rule out variations of the cross-sectional form and/or of the structure of the crest portion of the combustion-chamber sealing bead, provided these variations have a lesser influence on the deformation resistance of the combustion-chamber sealing bead than the variations of the cross-section and/or of the structure of the bead legs.

It may also be advantageous, in order to equalize the pressing forces acting on the installed and pressed cylinder-head seal, along the combustion-chamber sealing bead at least in regions of the intermediate portions of the combustion-chamber sealing bead, to additionally provide the crest portion of the combustion-chamber sealing bead with at least one stamped protrusion extending in the longitudinal direction of the combustion-chamber sealing bead, preferably in order to provide the crest portion additionally with a height profile extending in its longitudinal direction. If such a protrusion is intended to lead not only to a local reinforcement, but also to a local camber of the crest portion of the combustion-chamber sealing bead, the combustion-chamber sealing bead is formed such that the protrusion projects in the direction pointing away from the bead feet of the combustion-chamber sealing bead.

In order to attain the most favorable production costs possible, it is recommended to form the combustion-chamber sealing bead such that the latter, on its concave side, forms a groove extending in the bead longitudinal direction and preferably also into the crest portion, the depth and/or cross-section of said groove varying at least in longitudinal regions of the intermediate portions along the sealing bead, wherein, in cross-sections through the combustion-chamber sealing bead, the groove thereof and in particular also the crest portion thereof are formed preferably and at least substantially mirror-symmetrically with respect to a line running perpendicularly to the sealing layer plane; stamping tools which can be produced economically may then be used for the stamping of the combustion-chamber sealing bead.

In the case of a combustion-chamber sealing bead of which the cross-section is substantially rectangular or corresponds substantially to a trapezoid or a U, when the cylinder-head gasket is installed and pressed, the crest portion of the combustion-chamber sealing bead is acted on by greater pressing forces than each of the bead feet (pressing forces per length unit of the combustion-chamber sealing bead). In the case of engines in which the installation space available for accommodating the combustion-chamber sealing bead is limited in the radial direction in relation to the combustion-chamber opening, more specifically at least in some regions along the combustion-chamber sealing bead and/or only on one side of the cylinder-head seal, it is advantageous that in a cylinder-head gasket according to the invention it is not necessary to provide the combustion-chamber sealing bead, in particular the crest portion thereof, with a width profile along the bead; preferred embodiments of the cylinder-head gasket according to the invention are therefore characterized in that the width of the combustion-chamber sealing bead, as measured on the convex side of the combustion-chamber sealing bead in a plan view of the sealing layer, and/or the crest portion of the combustion-chamber sealing bead is at least substantially constant along the combustion-chamber sealing bead. When measuring the width of the crest portion, it is then possible to take into consideration the limited installation space available on the convex side of the combustion-chamber sealing bead for accommodating same, which is important above all for the following reasons: as already mentioned, at the time of installation and during operation of the cylinder-head seal, the crest portion of the combustion-chamber sealing bead is acted on by greater pressing forces than each of the bead feet, and therefore the crest portion brings about an improved gasket with respect to combustion-chamber gases than each of the individual bead feet; furthermore, it cannot be ruled out that the width of the combustion-chamber sealing bead, measured in a plan view of the sealing layer, on the concave side of said bead, that is to say on the side of its bead feet, increases at least in longitudinal regions of the bead when the bead legs are stamped and/or at the time of installation and during operation of the cylinder-head seal, but the width of the combustion-chamber sealing bead on its convex side, that is to say on the side of its crest portion, does not.

In this regard, the following should be noted: particularly in preferred embodiments of the cylinder-head gasket according to the invention, in particular if these embodiments comprise just a single sealing layer, the thickness of the sheet steel used for the sealing layer configured in accordance with the invention is much greater than 0.3 mm and is preferably at least twice or even at least three times the aforesaid value. Due to the above-described forming during the stamping of the combustion-chamber sealing bead into the sheet steel of the sealing layer, the steel is locally heavily deformed to differing extents in the region of the combustion-chamber sealing bead, and in so doing is strengthened, wherein the combustion-chamber sealing bead also attains such a strength in the region of its crest portion that the width of the crest portion does not change, or at least does not significantly change, at the time of installation and during operation of the cylinder-head seal, also because the pressing forces acting at this time on the crest portion run perpendicularly to the pressed side thereof, whereas the pressing forces acting on the combustion-chamber sealing bead could primarily cause the inclination of the bead legs (in cross-sections through the combustion-chamber sealing bead) to change; in preferred embodiments of the cylinder-head gasket according to the invention, however, the bead legs, on account of their cross-sectional form, their cross-sectional area and their structure brought about by the forming process, are configured in the intermediate portions such that the spacing between the two bead feet does not change, at least not significantly, also at the time of installation and during operation of the cylinder-head seal.

When realizing preferred embodiments of the invention, a combustion-chamber sealing bead is sought, along which the cross-section is at least approximately rectangular or trapezoidal, wherein in some longitudinal portions of the combustion-chamber sealing bead the cross-section may be at least approximately rectangular and in other longitudinal regions may be at least approximately trapezoidal. Here, such embodiments are characterized in particular by at least one of the following features:
(a) along the entire combustion-chamber sealing bead, the height of the bead legs amount perpendicularly to the plane of the sealing layer is at least substantially constant (in contrast to a combustion-chamber sealing bead which is provided with a height profile along the latter in longitudinal regions);
(b) along the entire combustion-chamber sealing bead, the longitudinal direction of each bead leg provided in cross-sections through the combustion chamber sealing bead forms an angle with the perpendicular to the sealing layer plane, the size of which angle is at least approximately 0° (in the case of an approximately rectangular bead cross-section) or at least approximately 5° to at least approximately 45° (in the case of an approximately trapezoidal cross-section);
(c) along the entire combustion-chamber sealing bead, the crest portion thereof on the convex side of the combustion-chamber sealing bead forms at least one support face, which extends along the combustion-chamber sealing bead and runs at least approximately parallel to the sealing layer plane (in a longitudinal region in which the crest portion is not provided with an aforementioned protrusion, the crest portion preferably forms only a single support face).

The invention also relates to a method for producing a cylinder-head gasket with at least one, and preferably only one, metal sealing layer, in which there are provided at least one combustion chamber opening and, around said opening, screw holes for the passage of cylinder-head screws, and a combustion-chamber sealing bead stamped in the sealing layer, wherein the combustion-chamber sealing bead, on its convex side, has a crest portion which extends along the combustion-chamber sealing bead, in a plan view of the sealing layer between two bead legs, or, in a cross-section through the bead, above or below two bead legs, by means of which bead legs the crest portion is connected to regions of the sealing layer bordering the combustion-chamber sealing bead and into which regions the bead legs transition in each case by a bead foot, and wherein, in a plan view of the sealing layer, the screw holes are arranged at a spacing from the combustion-chamber opening and at spacings from one another in the peripheral direction of the combustion-chamber opening, and the combustion-chamber sealing bead runs between the combustion-chamber opening and the screw holes, and also has screw portions, each of which lies closest to a screw hole, and intermediate portions between the screw portions.

In order to attain local and in particular also different increases in the deformation resistance or the rigidity of intermediate portions of the combustion-chamber sealing bead with respect to pressing forces oriented perpendicularly to the sealing layer and acting on the crest portion of said bead, bead legs are produced during the stamping of intermediate portions of the combustion-chamber sealing bead, at least in longitudinal regions of the intermediate portions, and the cross-sectional form and/or area and/or structure of said bead legs varies
(a) along these longitudinal regions of the intermediate portions
and/or
(b) along the bead legs in cross-sections through the latter in at least part of these cross-sections,

such that the deformation resistance of each of the bead legs of the combustion-chamber sealing bead with respect to pressing forces oriented perpendicularly to the sealing layer and acting on the crest portion of said bead is locally different along the combustion-chamber sealing bead, at least in these longitudinal regions of the intermediate portions.

The aforesaid cross-sections are regions of cross-sections through the various intermediate portions arranged in succession along the intermediate portions and in each case constitute a section through the entire profile of the particular intermediate portion.

The above-stated feature (b) shall be understood in conjunction with the arrangement of the production method according to the invention in particular such that, at least in longitudinal regions or portions of the intermediate portions at least in some, preferably in most, and in particular in all cross-sections through these longitudinal regions of the intermediate portions, the cross-sectional form and/or area or the material thickness and/or the structure of the bead legs varies or changes along the bead legs, that is to say viewed in an aforementioned cross-section along each of the bead legs.

Particularly advantageous embodiments of the method according to the invention are characterized in that, as the combustion-chamber sealing bead is stamped into the sealing layer, a basic bead with an at least substantially constant cross-section along the basic bead and with screw portions, each of which lies closest to a screw hole, and intermediate portions situated between said screw portions is firstly stamped in the sealing layer, and in that at least longitudinal regions of these intermediate portions of the basic bead are then formed by stamping, at least such that the bead legs of the combustion-chamber sealing bead that vary in their cross-section or their material thickness and/or their structure are then produced; the second stamping process is advantageously arranged such that, at least in the intermediate portions of the basic bead, the crest region thereof is also formed such that the final form of the crest portion of the combustion-chamber sealing bead is thus achieved, but in particular so too is a strengthening of the metal in the region of the final crest portion brought about by the forming process.

In principle, however, it is also possible, with the aid of stamping tool parts tailored to the combustion-chamber sealing bead to be produced, to manage with just a single stamping process when carrying out the production method according to the invention.

It is particularly advantageous if the production method according to the invention is arranged such that, when stamping the intermediate portions of the combustion-chamber sealing bead at least in longitudinal regions of the intermediate portions, the metal of the sealing layer, in particular predominantly the metal of the bead legs, is strain-hardened locally by impact extrusion or flow stamping.

If the crest portion of the combustion-chamber sealing bead of a cylinder-head gasket according to the invention (as mentioned above) is to be provided with at least one stamped protrusion extending in the longitudinal direction of the combustion-chamber sealing bead, this protrusion can be produced readily by any of the two above-described embodiments of the production method according to the invention; here, in view of the locally different strengths of regions of the combustion-chamber sealing bead that are to be achieved, it is advantageous to arrange the production method such that, during the stamping of an intermediate portion longitudinal region provided with the protrusion by impact extrusion or flow stamping, metal of the sealing layer is displaced into the bead legs and, in order to form the protrusion, into the crest portion.

The present invention also relates to a cylinder-head gasket produced by the method according to the invention.

Lastly, the present invention also relates to a multi-cylinder reciprocating internal combustion engine with an engine block, a cylinder head, and a cylinder-head seal, which is clamped and pressed by means of cylinder-head screws between component sealing faces of the engine block and of the cylinder head, and which has at least one, but in particular just a single, metal sealing layer, in which there are provided a combustion-chamber opening for each cylinder of the engine and, around said opening, screw holes for the passage of cylinder-head screws, and a combustion-chamber sealing bead stamped into the sealing layer, wherein the combustion-chamber sealing bead, on its convex side, has a crest portion extending in the bead longitudinal direction, which crest portion is arranged along the combustion-chamber sealing bead, in a plan view of the sealing layer between two bead legs, or, in a cross-section through the bead, above or below two bead legs, by means of which bead legs the crest portion is connected to regions of the sealing layer bordering the combustion-chamber sealing bead, into which regions the bead legs transition in each case by means of a bead foot, and wherein, in a plan view of the sealing layer, the screw holes are spaced from the combustion-chamber opening and are arranged at spacings from one another in the peripheral direction of the combustion-chamber opening, and the combustion-chamber sealing bead runs between the combustion-chamber opening and the screw holes and has screw portions, each of which lies closest to a screw hole, and between the screw portions has intermediate portions, and wherein at least one of the components constituted by the engine block and cylinder head has, in its component sealing face, at least one sealing face region, in which the component rigidity of this component with respect to pressing forces directed perpendicularly to its component sealing face is lower than in sealing face regions of this component adjacent to this sealing face region.

In accordance with the invention, in such an engine, the deformation resistance of the bead legs of the combustion-chamber sealing bead of the cylinder-head gasket with respect to pressing forces oriented perpendicularly to the sealing layer of the cylinder-head gasket and acting on the crest portion of the combustion-chamber sealing bead is greater, at least in longitudinal regions of the intermediate portions of the combustion-chamber sealing bead, than in screw portions of the combustion-chamber sealing bead, wherein, along at least one intermediate portion of the combustion-chamber sealing bead of the clamped and pressed cylinder-head seal, the deformation resistance of the bead legs is adapted at least to the locally different component rigidity of the at least one component constituted by the engine block or cylinder head in the region of its component sealing face pressed against the intermediate portion of the combustion-chamber sealing bead, in such a way that sealing face regions of lower component rigidity are associated with bead leg regions of greater deformation resistance.

Here as well, the deformation resistance of the bead legs shall be understood to mean their deformation resistance with respect to pressing forces acting on the combustion-chamber sealing bead perpendicularly to the sealing layer.

The rigidity of the combustion-chamber sealing bead may thus be adapted to locally different component rigidities in such a way that locally reduced component rigidities also as a result of cavities can be taken into account.

In what is known as a liner engine, the engine block for each cylinder has a cylinder liner with a liner sealing face facing the cylinder-head gasket and cooperating therewith, with a liner sealing face region surrounding the axis of the cylinder liner. In particular, the combustion-chamber sealing bead of the installed cylinder-head gasket is pressed against this liner sealing face region, which is usually circular ring-shaped in a plan view of the cylinder liner, so as to gasket the cylinder as closely as possible to its cavity with respect to an escape of the combustion gases forming in the cylinder at high pressures. Since, in many liner engines, the aforementioned annular liner sealing face has a relatively small radial width (in relation to the liner axis) and therefore defines the installation space available on the side of the engine block for accommodating the combustion-chamber sealing bead, the use of a cylinder-head gasket according to the invention in a liner engine entails significant advantages; as is clear from the above descriptions of preferred embodiments of the cylinder-head gasket according to the invention, preferred embodiments of the internal combustion engine according to the invention configured as liner engines are characterized in that the combustion-chamber sealing bead according to the invention abuts with its crest portion against the above-described liner sealing face region, in order to thus particularly effectively and easily solve the problem, caused by the aforementioned liner sealing face, of a limited installation space on the side of the engine block for accommodating the combustion-chamber sealing bead.

Features, advantages and details of the invention will also become clear from the accompanying claims and/or from the accompanying graphical representations of preferred embodiments of the invention and/or from the following description.

### BRIEF DESCRIPTION OF THE DRAWINGS

The accompanying drawings show:

FIG. 1 shows a plan view of part of a cylinder-head gasket according to the invention for a multi-cylinder motor, wherein this gasket part is a longitudinal end region of the gasket containing two combustion-chamber openings;

FIG. 2 shows a plan view of a longitudinal end region of the engine block sealing face corresponding to the longitudinal end region of the cylinder-head gasket shown in FIG. 1 and intended to clamp the gasket part shown in FIG. 1 between the part of the engine block sealing face shown in FIG. 2 and a correspondingly configured part of the cylinder-head sealing face;

FIG. 3 shows a somewhat schematic section along the line 3-3 in FIG. 1, more specifically through a single-layer cylinder-head gasket according to the invention;

FIG. 4 shows a likewise somewhat schematic section along the line 4-4 in FIG. 1 through the single-layer cylinder-head gasket also shown in FIG. 3, but on a larger scale than FIG. 3;

FIG. 4A shows a detail from FIG. 4, specifically the cross-section shown in FIG. 4 through the combustion-chamber sealing bead in an intermediate portion of the latter on a larger scale than in FIG. 4;

FIG. 5A shows part of the section shown in FIG. 3, but with contours corresponding substantially to those of a combustion-chamber sealing bead actually produced, more specifically in a screw region or portion;

FIG. 5B shows part of the section shown in FIG. 4, but with contours which correspond substantially to those of a combustion-chamber sealing bead actually produced, more specifically in an intermediate screw region or portion;

FIG. 6 shows a section through part of an engine block of a liner engine accommodating a cylinder linear, a region thereabove of a single-layer cylinder-head gasket according to the invention, and part of a cylinder head, wherein the sectional plane coincides with a diametric plane of the cylinder liner and traverses an intermediate portion of the combustion-chamber sealing bead; and

FIG. 7 shows a schematic diagram of the deformation resistance of a combustion-chamber sealing bead arranged in accordance with the invention, showing, somewhat schematic and, for explanation, on an enlarged scale as compared to the situation in reality, the differences in the deformation resistance along part of the combustion-chamber sealing bead comprising two screw portions and an intermediate portion of the combustion-chamber sealing bead.

### DETAILED DESCRIPTION

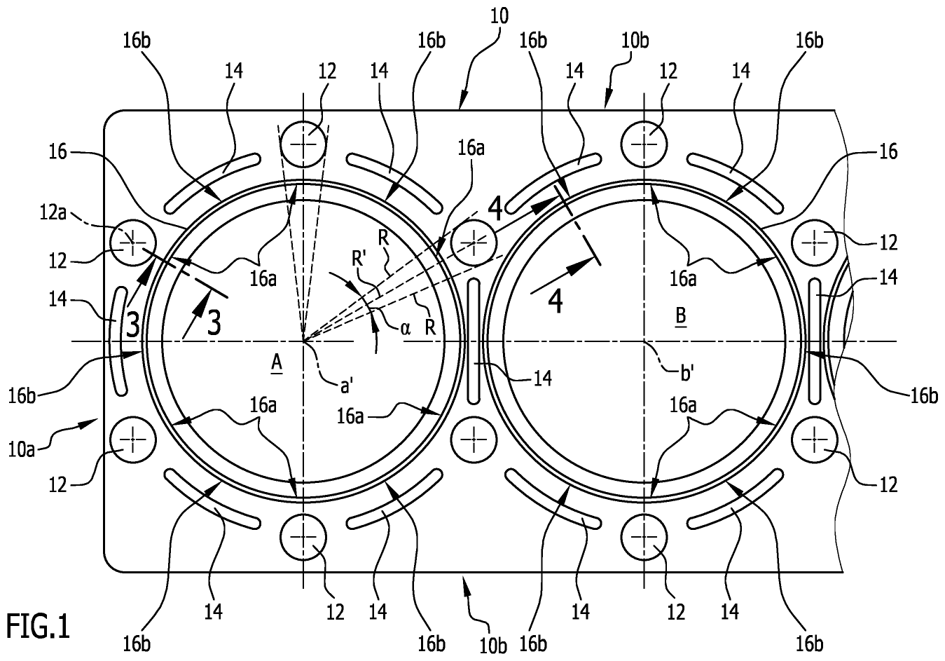

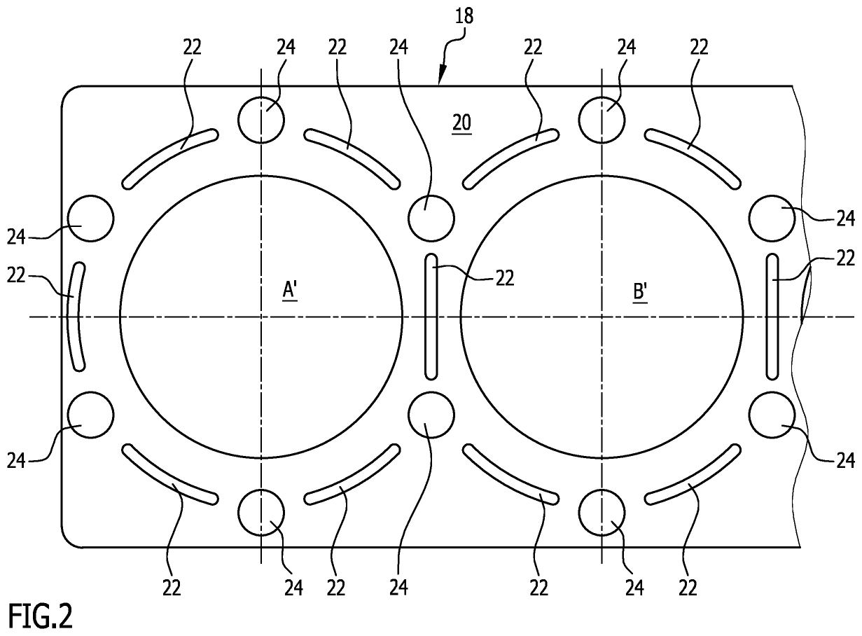

FIG. 1 shows, in a plan view, a region of a metal sealing layer 10 of a cylinder-head gasket according to the invention, in which the cylinder-head gasket is a single-layer cylinder-head seal, which therefore has only a single sealing layer. The shown sealing layer region has a narrow side edge 10a and two longitudinal side edges 10b and has two combustion-chamber openings A and B, screw holes 12 for the passage of cylinder-head screws (not shown), and fluid passage openings 14, which in the present case are all through-openings for cooling water. As will also be explained with reference to FIG. 2, the engine components constituted by the engine block and cylinder head belonging to this cylinder-head gasket have cavities for the fluid (in this case cooling water) associated with the through-openings 14 of the cylinder-head gasket and arranged below and above the cylinder-head gasket respectively, which cavities open out into the component sealing faces of the engine block and cylinder head accommodating the cylinder-head gasket in-between and communicate with one another by means of the through-openings 14. In order to seal the fluid flows flowing through the through-openings 14, sealing means known from the prior art may be provided on the cylinder-head seal, for example fluid sealing beads stamped into the sealing layer 10 and surrounding the through-openings 14, or elastomer sealing elements mounted on the sealing layer 10, for example molded integrally on the sealing layer, which sealing elements surround through-openings 14 and protrude from both main surfaces of the sealing layer 10, that is to say from the underside and upper side thereof.

For each of the combustion-chamber openings of the sealing layer 10, a combustion-chamber sealing bead 16 is stamped into said sealing layer, wherein FIG. 1 of course shows only the combustion-chamber sealing beads 16 for the combustion-chamber openings A and B.

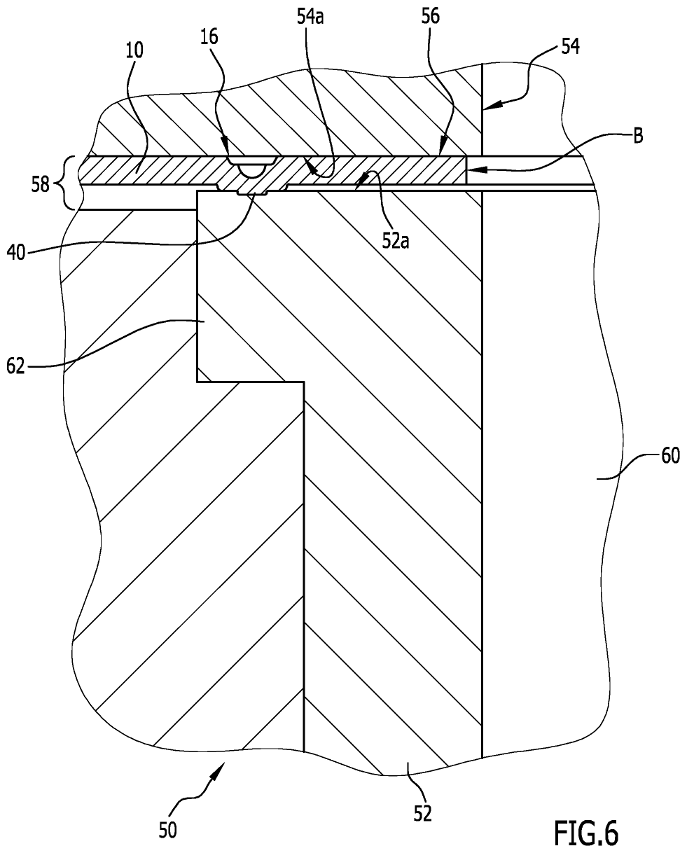

The part of an engine block 18 associated with the part of the cylinder-head gasket shown in FIG. 1, that is to say the sealing layer 10, is shown in plan view in FIG. 2; on its side facing the sealing layer 10 in the assembled state of the engine, the engine block 18 has an engine block sealing face 20, on which the sealing layer 10 is placed during assembly of the engine, so as to then be clamped between the engine block sealing face 20 and a sealing face of the cylinder head of the engine (see also FIG. 6, which is yet to be explained). If the engine is what is known as a liner engine, the engine block 18 also contains cylinder liners, not shown in FIG. 2 (again, see FIG. 6).

In the schematically shown embodiment, cavities (not visible in FIG. 2) for fluids, such as engine oil and cooling water, are provided in the engine block and open out into the engine block sealing face 20; FIG. 2, however, shows only discharge openings 22 by which cooling water cavities provided in the engine block 18 open out into the engine block sealing face 20. In the schematically shown embodiment, the discharge openings 22, when the engine is in the assembled state, are arranged and configured congruently with the through-openings 14 in the sealing layer 10; the through-openings 14 and the discharge openings 22 could, however, also be arranged differently in principle.

Lastly, FIG. 2 also shows cylinder openings A′ and B′ in the engine block sealing face 20 which correspond to the combustion-chamber openings A and B in the sealing layer 10, as well as bores 24 (generally threaded bores) for cylinder-head screws, the axes of which, when the engine is in the assembled state, are aligned with screw hole axes 12a of the screw holes 12 in the sealing layer 10.

As can be seen in FIG. 1, each combustion-chamber sealing bead 16 has screw portions along its length, each of which screw portions, in a plan view of the sealing layer 10, lies closest to a screw hole 12, and, between the screw portions, has intermediate portions adjoining them—in FIG. 1 only a few screw portions and intermediate portions have been denoted by 16a and 16b respectively; the points at which the screw portions border the intermediate portions of the combustion-chamber sealing bead 16 may lie in radial planes R (see FIG. 1) which start from the axis a′ orb′ of the combustion-chamber opening A or B respectively, lie on each side of a screw hole 12 and are tangential thereto. In contrast to that shown in FIG. 1, the two radial planes R associated with each screw hole 12 may also in each case form an angle with a radial plane R′ containing the axis a′ or b′ and the screw hole axis 12a of the screw hole, which angle is greater than the angle α (alpha) shown in FIG. 1, is bisected by the plane R′, and in particular is at least 20°. Those points at which the screw portions 16a border the intermediate portions 16b or transition into the latter, consequently also define the length of the screw portions and intermediate portions or the circumferential angles, with respect to the axis of the associated combustion-chamber opening, over which the screw portions or intermediate portions extend. The above definitions for the lengths of the screw portions and the intermediate portions apply for preferred embodiments of the cylinder-head gasket according to the invention; the screw portions or intermediate portions, however, may also be slightly shorter or in particular slightly longer than stated above, in particular by in each case up to 10% of the relevant above-mentioned circumferential angle.

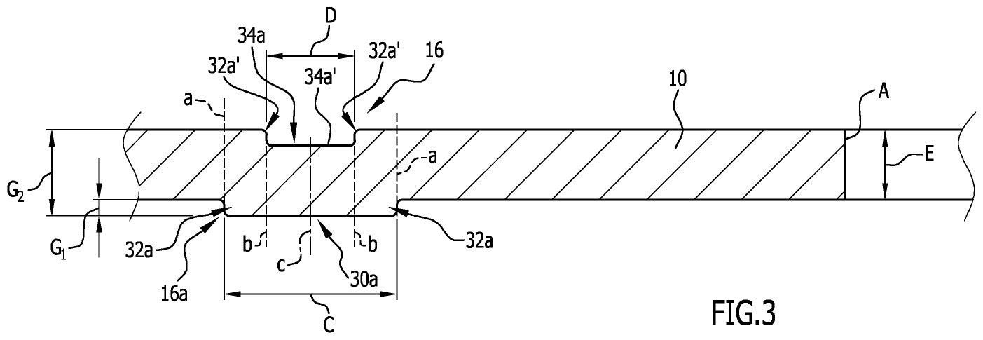

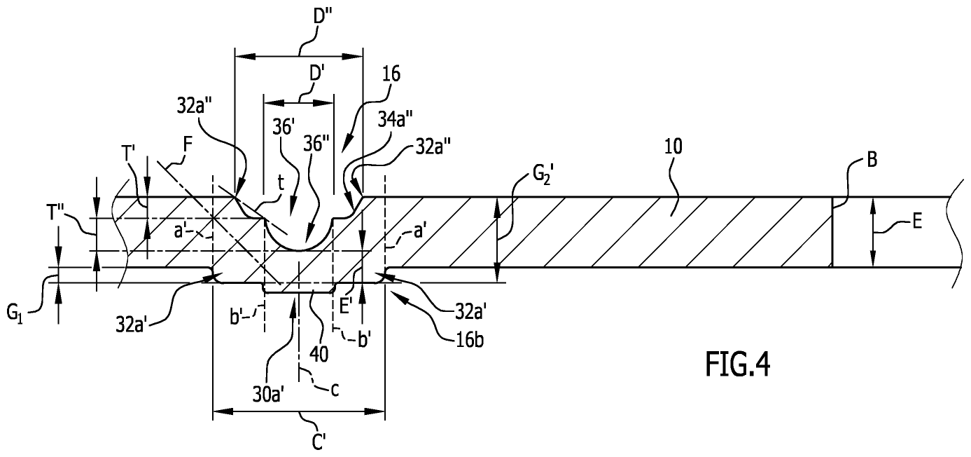

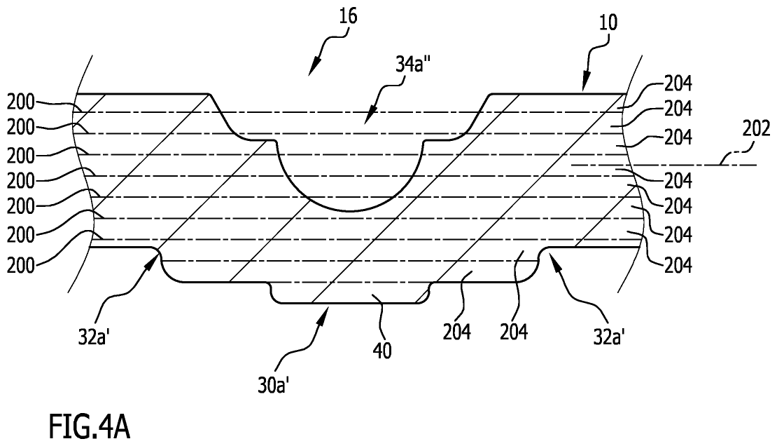

FIG. 3 shows a section through a screw portion 16a of a combustion-chamber sealing bead 16, more specifically a section along the line 3-3 in FIG. 1, whereas FIG. 4 shows a section through an intermediate portion 16b of the combustion-chamber sealing bead 16, more specifically a section along the line 4-4 in FIG. 1.

The method according to the invention for producing a cylinder-head gasket according to the invention can also be explained with reference to FIGS. 3 and 4, more specifically in an embodiment of the production method in which the combustion-chamber sealing bead 16 could be produced by means of at least two stamping processes, wherein a basic bead with a cross-section that is at least substantially constant along the basic bead and with screw portions, each of which lies closest to a screw hole, and with intermediate portions between said screw portions is firstly stamped into the sheet steel used for the sealing layer 10, and wherein at least longitudinal regions of these intermediate portions of the basic bead are formed by a further stamping process at least such that bead legs of the combustion-chamber sealing bead which vary in respect of their cross-sectional shape and/or cross-sectional area and/or material thickness and/or their structure are produced in longitudinal regions of the intermediate portions.

There are preferred, however, embodiments of the production method according to the invention which manage with a single stamping process and in which stamping tool parts tailored to the screw regions and the intermediate screw regions of the combustion-chamber sealing bead to be produced are used; such a stamping tool can be constructed readily by any fabricator experienced in the field of stamping tools for the production of flat metal gaskets.

As can be seen in FIG. 3, the combustion-chamber sealing bead 16, in its screw portion 16a and preferably in all of its screw portions 16a, has the form of what is known as a rectangular bead, which means that the crest portion of the combustion-chamber sealing bead, in a screw portion in the cross-section through said bead, runs approximately parallel to the actual sealing layer 10 and is connected to the sealing layer by means of two bead legs oriented at least approximately perpendicularly to the plane of the actual sealing layer 10. In FIG. 3, that is to say in the region of the screw portion 16a, the crest portion has been denoted by 30a, and the bead legs have been denoted by 32a. It can also be seen in FIG. 3 that, in the cross-section through the combustion-chamber sealing bead 16, the transitions of the crest portion 30a into the bead legs 32a as well as the transitions of the latter into the actual sealing layer 10 are slightly rounded, more specifically as the combustion-chamber sealing bead 16 is stamped into the sealing layer 10.

It will also be explained hereinafter, with reference to FIGS. 3 and 4, what is to be understood by the bead legs in the case of a combustion-chamber sealing bead formed as a rectangular bead in the screw portions and the intermediate portions.

It is now stressed once again, however, that in the case of a combustion-chamber sealing bead according to the invention the bead legs each transition by a bead foot into the regions of the sealing layer bordering the combustion-chamber sealing bead; in FIG. 3 the bead feet formed by the two bead legs 32a have been denoted in each case by 32a′.

In the screw portion 16a, the combustion-chamber sealing bead 16 on its convex side (on the underside of the crest portion 30a according to FIG. 3) with its crest portion 30a forms a plateau, and on its concave side (on the upper side of the combustion-chamber sealing bead according to FIG. 3) forms a groove 34a, of which the groove base 34a′ runs in particular at least approximately parallel to the plane of the actual sealing layer 10 (in cross-section through the combustion-chamber sealing bead).

In FIG. 3 the width of the crest portion 30a and thus the width of the combustion-chamber sealing bead 16 on its convex side has been denoted by C, and the width of the groove 34a has been denoted by D; since the combustion-chamber sealing bead 16 has been stamped into the sheet steel of the sealing layer 10, D/C<1, wherein the ratio D:C is dependent on the material thickness E of the actual sealing layer 10 and decreases with increasing material thickness. In preferred embodiments of the invention the following is true for the dimensions C and D and also for the material thickness E of the actual sealing layer 10:
C:E equals 2.7 to 2.3, in particular approximately 2.5
C:D equals 2.4 to 1.6, in particular approximately 2
E is 1 to 1.5, in particular approximately 1.2 mm.

In preferred embodiments of the cylinder-head gasket according to the invention the combustion-chamber sealing bead 16, in a screw portion 16a along said bead, has at least substantially all over the same cross-section and the same cross-sectional dimensions (before installation, that is to say before the cylinder-head gasket is pressed). This is the case in particular if the length of a screw portion 16a measured along the combustion-chamber sealing bead 16 is defined such that, in a plan view of the sealing layer 10, a screw portion 16a is delimited by two radii, which start from the axis of the combustion-chamber opening associated with the combustion-chamber sealing bead and are tangential to the screw hole lying closest to this screw portion 16a (reference may be made in this regard to FIG. 1), or if the screw portion is only slightly longer.

In the above-described embodiment of the production method according to the invention with two stamping processes, in which, in order to produce the combustion-chamber sealing bead, a basic bead is firstly stamped by a first stamping process into the sheet steel used for the production of the sealing layer 10, the combustion-chamber sealing bead 16 in its screw portions 16a preferably has the form, that is to say the cross-sectional shape and the cross-sectional dimensions, of this basic bead—in the embodiment shown in FIGS. 3 and 4, FIG. 3 thus reproduces the cross-section of said basic bead.

FIG. 3 and the above description thereof are also applicable, however, for combustion-chamber sealing beads which are produced by other embodiments of the production method according to the invention and which are formed as rectangular beads in screw portions and are formed slightly differently from a typical rectangular bead in intermediate portions on account of the different forming process performed there.

FIG. 4, showing a section along the line 4-4 in FIG. 1, shows a section through an intermediate portion 16b of the combustion-chamber sealing bead 16, that is to say as applicable a section through the combustion-chamber sealing bead after execution of the second stamping process of the above-explained two-stage method for producing the combustion-chamber sealing bead. As the intermediate portion 16b is stamped, the sheet metal of the sealing layer is deformed in the regions that later constitute the bead legs in intermediate portions, but preferably also the crest portion, more specifically at least in longitudinal regions of the intermediate portions 16b, such that, at least in longitudinal regions of the intermediate portions, bead legs are provided, for which the material thickness and/or structure of the metal of the sealing layer varies, in cross-sections through these longitudinal regions, along these longitudinal regions of the intermediate portions and/or along the bead legs (in each case in such a cross-section), in at least some of these cross-sections, such that the deformation resistance of the combustion-chamber sealing bead measured in the direction of the screw hole axes is locally different along the combustion-chamber sealing bead, at least in these longitudinal regions of the intermediate portions.

As can be seen from the line of section 4-4 from FIG. 1, FIG. 4 shows a cross-section through an intermediate portion 16b of the combustion-chamber sealing bead 16 at a point of said bead which, in a plan view of the sealing layer, lies in the middle between two mutually adjacent screw holes 16 (the radius defined by the line 4-4 and starting from the axis b′ of the combustion-chamber opening B lies in the middle between the two radii which run through the axes or centers of the two screw holes 12 lying on either side of the line 4-4).

In FIG. 4 the crest portion of the combustion-chamber sealing bead 16 has been denoted by 30a′, and the bead legs have been denoted by 32a′, since the cross-sectional forms and dimensions thereof differ from those of the crest portion 30a and the bead legs 32a of the combustion-chamber sealing bead 16 in FIG. 3, that is to say in a screw portion 16a.

FIG. 4 shows a cross-section through an intermediate portion 16b of a preferred embodiment of the cylinder-head gasket according to the invention, however features which are also comprised by other advantageous embodiments of an intermediate portion can also be derived from FIG. 4, specifically the following features:

At least in longitudinal regions of an intermediate portion 16b, there is a channel, denoted in FIG. 4 by 36′, at the location of the groove 34a of a screw portion 16a (see FIG. 3), which channel, starting from the side of the sealing layer 10 arranged on the concave side of the combustion-chamber sealing bead 16, forms a groove 34a″ which is adjoined in the direction of the convex side of the combustion-chamber sealing bead 16 by a groove-shaped additional recess 36″, which in a plan view of the concave side of the combustion-chamber sealing bead 16 is preferably narrower than the groove 34a″ and/or in cross-section through the combustion-chamber sealing bead 16 is in particular deeper than the groove 34a″. As an intermediate portion 16b, in particular at least a longitudinal region of the intermediate portion configured in accordance with the invention, is stamped, the groove 34a″ may be configured at least over part of its length such that there the width D″ of the groove 34a″ is slightly larger than the width D of the groove 34a of a screw portion 16a, as is clear from a comparison of FIGS. 3 and 4. The recess 36″ preferably has a cross-section of which the outer edge has a continuous curvature, that is to say no corners or steps, and in particular this outer edge has at least substantially the form of a circular arc, part of an ellipse or parabola, or the like. In preferred embodiments the maximum depth of the recess 36′ is greater than the depth of the groove 34a″, and/or the maximum width of the recess 36″ is at least 20%, in particular at least 30%, and preferably at least 40% smaller than the maximum width of the groove 34a″, in particular, however, the maximum width of the recess 36″ is at most 10% to 60% smaller than the maximum width of the groove 34a″ (in each case measured in a cross-section through or in a plan view of the combustion-chamber sealing bead 16).

As can be seen in FIG. 4, and more specifically this being only an example of the present invention, the channel 36′ in a cross-section through an intermediate portion of the combustion-chamber sealing bead, in particular through at least one longitudinal region of the intermediate portion configured in accordance with the invention, has an outer edge which will be referred to hereinafter as the contour of the channel. In relation to a perpendicular to the sealing layer plane defined by the sealing layer (in FIG. 4 the perpendicular is the same as the center line c), this contour has two contour portions facing away from one another. In the above-mentioned cross-section, the contour of the channel may have a continuous curvature overall, or the contour may have steps, more specifically where the additional recess (denoted by 36″ in FIG. 4) has its greatest width (as is the case in the embodiment shown in FIG. 4). In the latter case, a tangent (denoted by t in FIG. 4) can be placed against the concave side of the contour of the channel, more specifically against each of the aforementioned contour portions, and runs inside the channel, whereas in the first-mentioned case above, specifically when the contour of the channel has a continuous curvature overall, a tangent may be placed against the convex side of the contour of the channel, more specifically against each of the aforementioned contour portions, and consequently runs outside the channel. In each of these two cases, each of the tangents placed against the aforementioned contour portions forms an angle with a perpendicular to the sealing layer plane, the size of which angle is at least approximately 10° to at least approximately 50° (specifically if the combustion-chamber sealing bead is a rectangular bead), or at least approximately 20° to at least approximately 60° (specifically if the combustion-chamber sealing bead is a trapezoidal bead).

The following references have been used in FIG. 4
D′=maximum width of the recess 36″,
D″=maximum width of the groove 34a″ and thus maximum width of the channel 36′,
T′=depth of the groove 34a″, and
T″=maximum depth of the recess 36″.

As the groove 34a″ is stamped, a maximum groove width D″ and/or a maximum groove depth T′ are formed and, respectively, may be slightly larger, but also slightly smaller than the width D and the depth of the groove 34a of the combustion-chamber sealing bead 16 in a screw portion 16a.

In preferred embodiments, in a cross-section through an intermediate portion 16b of the combustion-chamber sealing bead 16, in particular in a cross-section through a longitudinal region of the intermediate portion configured in accordance with the invention, the transitions of the recess 36″ into the groove 34a″ as well as the transitions of this groove into the adjacent side of the sealing layer 10 are rounded.

FIG. 4 shows a protrusion 40 which is formed by the crest portion 30a′ and which is yet to be described in greater detail.

The following feature of preferred embodiments of the invention is also comprehensible from FIG. 4 and its comparison with FIG. 3:

In the regions bordering the two sides of the combustion-chamber sealing bead 16, the sealing layer 10 has a material thickness E; this material thickness is in particular the sheet thickness of the sheet steel used for the production of the sealing layer 10. In an intermediate portion 16b, in particular in a longitudinal region of the intermediate portion configured in accordance with the invention, the material thickness E′ of the sealing layer 10 at the deepest point of the recess 36″ is smaller than the material thickness of the sealing layer 10 between the base of the groove 34a and the face of the crest portion 30a (lower face of the crest portion according to FIG. 3) of a screw portion 16a of the combustion-chamber sealing bead 16 acted on by pressing forces when the cylinder-head gasket is in the installed position, more specifically in particular also if the crest portion 30a does not have a protrusion 40 of the above-mentioned kind in a longitudinal region of an intermediate portion 16b configured in accordance with the invention. In this regard it is noted that in preferred embodiments of the cylinder-head gasket according to the invention, in the screw portions 16a, the material thickness of the sealing layer between the base of the groove 34a and the face of the crest portion 30a acted on by pressing forces when the cylinder-head gasket is in the installed position is at least substantially the same as the sheet thickness E; in preferred embodiments of the cylinder-head gasket according to the invention, E′ should thus be smaller than E, more specifically also under consideration of the tolerances of the sheet thickness of the sheet steel used for production of the sealing layer 10. If a combustion-chamber sealing bead, of a sealing layer of a conventional cylinder-head seal, configured as a rectangular bead is provided, as is known, with a height profile in an intermediate portion, as could also be shown by FIG. 3 in a cross-section, the material thickness of the sealing layer between the base of the concave side and the camber of the convex side of the combustion-chamber sealing bead, by contrast, in the combustion-chamber sealing bead is at least substantially the same as the material thickness of the sealing layer in its layer regions arranged on both sides of the combustion-chamber sealing bead.

Since the invention relates to a combustion-chamber sealing bead which is provided in a sealing layer of a cylinder-head gasket and which has a crest portion extending in the thickness longitudinal direction, which crest portion is connected by means of two bead legs of the combustion-chamber sealing bead to regions of the sealing layer bordering said bead, the bead legs transitioning into said regions in each case by a bead foot of the relevant bead leg, in FIG. 3 the bead feet of the two bead legs 32a have been denoted by 32a′, and in FIG. 4 the bead feet of the two bead legs 32a′ have been denoted by 32a″.

When producing the intermediate portions 16b, in particular a longitudinal region configured in accordance with the invention of an intermediate portion of this kind, material of the sealing layer is displaced, during the stamping of the channel 36′, more specifically primarily its recess 36″, in directions which point towards the bead legs 32a′ formed as a result of the stamping. The stamping tool or a tool part thereof may also be configured readily such that, as the channel 36′, primarily the recess 36″, is stamped, material of the sealing layer is also displaced in the direction of the crest portion of the intermediate portion 16b to be produced, and therefore the crest portion 30a′ is provided at least in longitudinal regions of the intermediate portions 16b with at least one protrusion 40, which extends preferably in the longitudinal direction of the combustion-chamber sealing bead 16.

In preferred embodiments of the cylinder-head gasket according to the invention, as the intermediate portions 16b are stamped, more specifically in particular as the recess 36″ is stamped, the metal of the sealing layer 10 is strain-hardened on account of the cold forming at least also in regions of the crest portion 30a′, more specifically also if an intermediate portion 16b is not provided with a protrusion 40.

As can be seen from a comparison of FIGS. 3 and 4, during the production of an intermediate portion 16b, in particular of a longitudinal region configured in accordance with the invention of the intermediate portion, when the final form of the intermediate portion is produced, the metal of the sealing layer 10 when forming the bead legs 32a′ in the region thereof is particularly strongly deformed, so as to attain, in an intermediate portion 16b, bead legs of the combustion-chamber sealing bead 16, the cross-sections of which correspond qualitatively to the cross-sections of the bead legs 32a′ shown in FIG. 4 (at least in longitudinal regions of the intermediate portions).

In preferred embodiments of the cylinder-head gasket according to the invention, however, the cross-sectional shapes and cross-sectional dimensions of the bead legs 32a′ vary along an intermediate portion 16b, in particular at least along a longitudinal region or a plurality of longitudinal regions of the intermediate portion 16b, so as to achieve an equalization of the pressing forces, which are exerted by the intermediate portions 16b onto the component sealing faces of the engine components constituted by the engine block and cylinder head, along the combustion-chamber sealing bead at the time of installation and during operation of the cylinder-head seal. In the case of a cylinder-head gasket according to the invention, this equalization of the pressing forces is based at least primarily on the fact that the cross-sectional shape and/or dimensions and/or area and/or the material thickness of the bead legs and/or the structure of the metal of the bead legs varies or vary along these longitudinal regions of the intermediate portions and/or varies or vary in at least some cross-sections through these longitudinal regions along the bead legs (in the relevant cross-section)—in FIG. 4 a variation along, for example, the left bead leg 32a′ according to FIG. 4 means a variation along approximately the direction of the dot-and-dash line F that can be seen in FIG. 4.

In this regard it is noted that, in order to stamp the combustion-chamber sealing bead 16, a stamping tool can be readily used of which the cross-section changes along the combustion-chamber sealing bead or intermediate portions to be stamped and/or along the bead legs (in each case in a cross-section through the combustion-chamber sealing bead) in accordance with the desired result of the stamping process.

If the intermediate portions 16b are to be provided at least in longitudinal regions thereof with a protrusion, such as the protrusion 40 shown in FIG. 4, this can also be readily achieved using an appropriately configured stamping tool, and the same is true for the case in which the height and/or width of such a protrusion varies along said protrusion, that is to say the protrusion has a height and/or width profile.

For the sake of completeness, the following is also noted:
(a) the deformation resistance of a bead leg, such as one of the bead legs 32a′, with respect to pressing forces acting on the combustion-chamber sealing bead perpendicularly to the sealing layer 10, can be achieved not only by a variation of the material thickness of the bead leg, but alternatively and/or additionally also by a variation of the bead leg cross-section with at least substantially constant material thickness;
(b) if metals, in particular steels, are cold-worked or cold-formed, this results in structural changes to the metal, and due to such structural changes the strength of the metal is also changed (the greater the degree of deformation in a region of an object made of steel, the greater is also the strengthening of the steel in this region); different strengths of the metal, also in some regions, consequently result due to a different structure of the metal in some regions.

As is clear from the above, in preferred embodiments of the cylinder-head gasket according to the invention, the combustion-chamber sealing bead, along its intermediate portions (the intermediate portions 16b in the embodiment shown in the drawings), has different cross-sections, and in particularly preferred embodiments the cross-sectional changes along the combustion-chamber sealing bead occur continuously, that is to say not abruptly. This is true in particular also for the transitions of the screw portions into the intermediate portions (in the embodiment shown in FIG. 1, that is to say for the transitions of the screw portions 16a into the intermediate portions 16b). In practice, this may mean that the cross-section of a screw portion 16a is not exactly constant over its total length, but instead changes slightly in the regions of the two ends of the screw portion 16a, such that a continuous transition into the two adjacent intermediate portions 16b is provided.

In FIG. 4A, which shows a cross-section through an intermediate portion of the combustion-chamber sealing bead on a larger scale than in FIG. 4, dot-and-dash lines indicate planes 200 which run parallel to one another and parallel to a plane 202 (the actual sealing layer 10) and extend along the total combustion-chamber sealing bead 16; here, the spacings between adjacent planes 200, as measured in the vertical direction according to FIG. 4A, are preferably of equal size. In the region of the combustion-chamber sealing bead 16, metal zones 204 are defined in this region and extend along the combustion-chamber sealing bead 16.

As the intermediate portions 16b are stamped, the metal used for the sealing layer 10, in particular a steel and preferably a steel that can be formed relatively well, that is to say a relatively ductile steel, is formed relatively strongly at least in longitudinal portions of the intermediate portions 16b extending along the combustion-chamber sealing bead 16, more specifically preferably by stamping or impact extrusion, such that, at least in longitudinal portions of the intermediate portions 16b extending along the combustion-chamber sealing bead 16, at least in some and preferably in all zones 204 of the bead legs 32a′, the material thickness and/or the structure of the metal of the bead legs varies along the combustion-chamber sealing bead 16, more specifically such that, along the combustion-chamber sealing bead 16, at least in these longitudinal portions, the deformation resistance of the combustion-chamber sealing bead, as measured in the direction of the screw hole axes 12a, is locally different along the combustion-chamber sealing bead; the material thicknesses of the bead legs 32a′ differing along the combustion-chamber sealing bead 16 are measured here in each case in cross-sections through the combustion-chamber sealing bead 16, more specifically preferably in said zones (204) in a direction parallel to the plane of the sealing layer (10). This means in particular that, at least in longitudinal regions of the intermediate portions (16b), at least in some and preferably in all of the aforesaid zones (204), the material thickness of the bead legs (32a′) measured in the above-described way varies along the combustion-chamber sealing bead (16), and therefore the deformation resistance of the combustion-chamber sealing bead (16), more specifically primarily of the bead legs (32a′), is locally different along the combustion-chamber sealing bead.

In preferred embodiments of the invention, along the entire combustion-chamber sealing bead, the height of the combustion-chamber sealing bead measured perpendicularly to the plane of the sealing layer is at least substantially constant, wherein, if, at least in longitudinal regions of the intermediate portions of the combustion-chamber sealing bead, the crest portion thereof is provided with a protrusion (such as the protrusion 40 shown in FIG. 4), this protrusion or the height thereof has remained out of consideration.

For the present invention, the height of the combustion-chamber sealing bead or of a bead leg shall be understood in particular to mean the following:
(a) the height of the combustion-chamber sealing bead is to be measured in a cross-section through the latter (again without a protrusion, such as the protrusion 40) and is equal to the amount by which the convex side of the combustion-chamber sealing bead protrudes beyond the regions of the sealing layer directly bordering the combustion-chamber sealing bead;
(b) the height of a bead leg is to be measured likewise in a cross-section through the combustion-chamber sealing bead, more specifically in a direction perpendicularly to the actual sealing layer and thus perpendicularly to the sealing layer plane, and is equal to the thickness of the sealing layer directly next to the combustion-chamber sealing bead, plus the amount by which the convex side of the combustion-chamber sealing bead protrudes beyond the regions of the sealing layer directly bordering the combustion-chamber sealing bead.

Subject to the above requirements, the amount G₁ shown in FIGS. 3 and 4 constitutes the height of the combustion-chamber sealing bead in a screw portion (FIG. 3) and in an intermediate portion (FIG. 4), and in both Figures the amount G₁ should have the same value if the combustion-chamber sealing bead does not have a height profile; in addition, in FIGS. 3 and 4 an amount G₂ or G₂′ is shown, respectively, which is the height of the bead legs in a screw portion (FIG. 3) or in an intermediate portion (FIG. 4), wherein in both Figures the amounts G₂ and G₂′ may have the same value, however the measure G₂′ may also be slightly greater than the amount G₂, if the combustion-chamber sealing bead has a height profile in an intermediate portion.

If the combustion-chamber sealing bead does not have a height profile in its intermediate portions, the amount G₁ in the screw and intermediate portions 16a and 16b respectively of the combustion-chamber sealing bead is at least the same; if the intermediate portions (16b), however, have a height profile, the amount G₁ at least in longitudinal regions of the intermediate portions is greater than in the screw portions.

The material thickness of the crest portions 30a and 30a′ (there without the protrusion 40) is in particular substantially the same as the amount G₁.

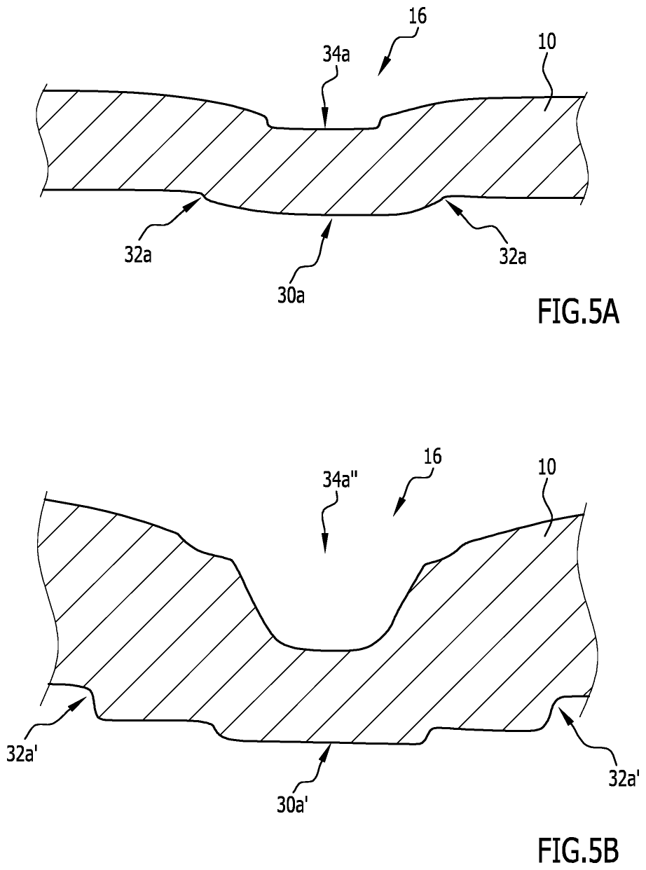

FIGS. 5A and 5B correspond to details from FIGS. 3 and 4, wherein the sectional illustrations shown in FIGS. 5A and 5B originate from microsections, taken from a test specimen of a sealing layer of a single-layer cylinder-head gasket produced in accordance with the invention. Reference signs from FIGS. 3 and 4 have been used in FIGS. 5A and 5B.

FIG. 6 shows a section through a region of a liner engine with a single-layer cylinder-head gasket according to the invention, wherein parts of an engine block 50 with inserted cylinder liner 52, a cylinder head 54, and a cylinder-head gasket 56 are shown in a longitudinal section such that the part of the cylinder-head gasket shown in FIG. 6 corresponds to the part of the sealing layer 10 shown in FIG. 4.

A sealing gap 58 accommodating the cylinder-head gasket 56 is formed by the engine block 50/cylinder liner 52 module and the cylinder head 54. In the region of the cylinder liner 52, a cylinder chamber of the engine has been denoted by 60. In its upper region in accordance with FIG. 6, the cylinder liner 52 has an annular flange 62, by means of which the cylinder liner 52 according to FIG. 6 is supported downwardly on the actual engine block 50. In the present case the cylinder liner 52 protrudes upwardly beyond the actual engine block 50 in accordance with FIG. 6.

With its upper end face in accordance with FIG. 6, the cylinder liner 52 forms a sealing face 52, against which the cylinder-head gasket 54 is pressed when, during the course of engine assembly, the cylinder-head screws (not shown) are tightened. Here, it is particularly advantageous if the combustion-chamber sealing bead 16 of the cylinder-head gasket 56 is supported by its convex side on the region of the sealing face 52a formed by the flange 62, because the cylinder-head gasket 56 is clamped around the cylinder chamber 60 with the highest pressing forces by the convex side of the combustion-chamber sealing bead, and therefore said pressing forces may be introduced into the actual engine block 50 by means of the flange 62.

FIG. 6, similarly to FIG. 4, shows a longitudinal region of an intermediate portion 16b of the combustion-chamber sealing bead 16 provided with a protrusion 40; in preferred embodiments of the invention this protrusion 40 is pressed during engine assembly and/or during the course of engine operation into the sealing face 52a of the cylinder liner 52, and this state is shown in FIG. 6.

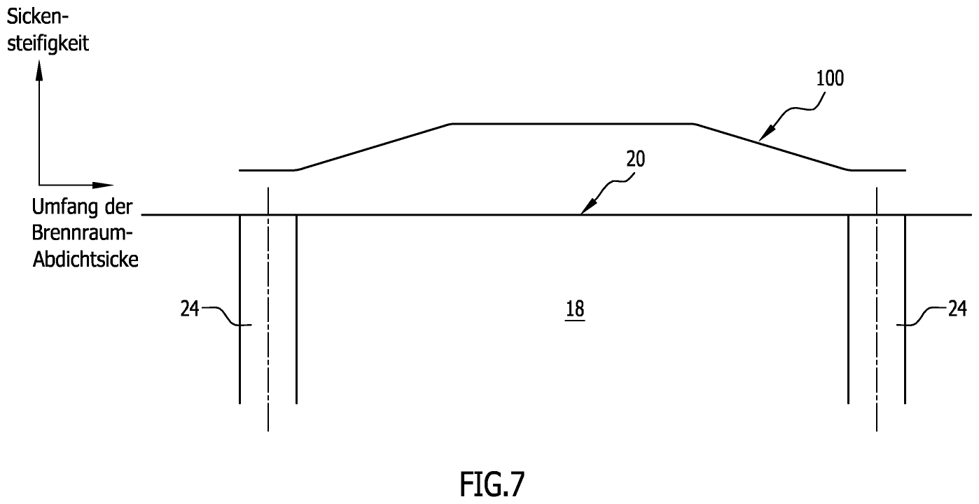

In FIG. 7 the course of the rigidity or of the deformation resistance of a combustion-chamber sealing bead configured in accordance with the invention along a peripheral portion of the latter is shown schematically and in simplified form, wherein FIG. 7 shall be understood in conjunction with FIGS. 1 and 2; thus, FIG. 7 schematically shows the engine block 18 with its engine block sealing face 20 and with two mutually adjacent bores 24 for cylinder-head screws (not shown). The course of the bead rigidity is limited to a region of the combustion-chamber sealing bead which comprises two screw portions 16a and an intermediate portion 16b. It is furthermore noted that FIG. 7 shows, schematically and in simplified form, a development of a region of the engine block 18, more specifically in a section through a region of the engine block 18 which partially surrounds one of the cylinder openings A′ and B′ shown in FIG. 2 and runs in the axial direction of the cylinder openings beneath the combustion-chamber sealing bead 16 shown in FIG. 1 and in a radial direction in front of the discharge openings 22 shown in FIG. 2.

For the region of the course of the bead rigidity shown above the engine block 18 by a curve, it has been assumed that the component rigidity of the engine block is reduced in the region of the combustion-chamber sealing bead 16 by a cavity for cooling water associated with a discharge opening 22, and that not only the fact that the engine components constituted by the engine block and cylinder head are not to be understood as absolutely rigid components has to be taken into consideration.

As is made clear by the curve denoted by 100 in FIG. 7, the combustion-chamber sealing bead 16 has its smallest rigidity in the direct vicinity of two mutually adjacent screw holes 12 (which are situated above the bores 24), not shown in FIG. 7; proceeding from these points of smallest bead rigidity, the curve 100 firstly rises and then reaches its highest region, more specifically next to and approximately along a through-opening 14 shown in FIG. 1. Between the lowest points of the curve 100 representing the smallest bead rigidity, the curve 100 may also have a different course: the curve 100 may thus firstly rise continuously between these points of smallest bead rigidity, and then immediately continuously descend again if the component rigidities of the engine block and cylinder head, underneath and/or above the intermediate screw region of the combustion-chamber sealing bead shown by FIG. 7, are not reduced by cavities in the engine block and/or the cylinder head; if, however, a plurality of such cavities leads to reductions in the component rigidity of engine block and/or cylinder head, the curve 100, between the points of smallest bead rigidity, may also have an undulating course to a greater or lesser extent, with a plurality of wave crests.

As is evident from the above description of the invention, these may also be defined, in particular for preferred embodiments, such that, in the case of a cylinder-head gasket of the kind described at the outset (see also the preamble of the accompanying claim 1), the profile of the combustion-chamber sealing bead (shape and/or area of the cross-section of the combustion-chamber sealing bead) and thus the deformation resistance of the combustion-chamber sealing bead changes along said bead at least in longitudinal regions (in other words in longitudinal portions) of the intermediate portions, such that, when the cylinder-head gasket is in the installed and pressed state, the pressing forces acting on the intermediate portions of the combustion-chamber sealing bead, along the intermediate portions, are sufficient all over for an adequate sealing of combustion-chamber gases and preferably are at least substantially of equal magnitude.

The above-mentioned change to the profile of the combustion-chamber sealing bead means that, during the production of the combustion-chamber sealing bead stamped into the sealing layer, in the intermediate portions along said bead, the metal of the sheet of the sealing layer is deformed to differing degrees, more specifically in particular and predominantly in the bead legs; in the case of a combustion-chamber sealing bead with a longitudinal groove or channel stamped into the sealing layer on its concave side and a crest portion extending along the combustion-chamber sealing bead on its convex side, this means, in other words, that in the intermediate portions of the combustion-chamber sealing bead along the intermediate portions, the cross-section of the groove or channel, in particular the depth and/or the cross-sectional shape of the groove or channel, is not constant, with the result that, along the intermediate portions, the deformability and the rigidity or the deformation resistance of the combustion-chamber sealing bead, in particular and predominantly the bead legs, is locally different—along the intermediate portions, these properties of the combustion-chamber sealing bead or of the bead legs in longitudinal regions of the latter are thus greater or smaller than at other points, wherein such a point shall be understood in each case to mean a cross-section through the combustion-chamber sealing bead. In embodiments in which the crest portion of the combustion-chamber sealing bead is provided, at least in longitudinal regions of the intermediate portions, with a protrusion of the aforementioned kind, the combustion-chamber sealing bead of preferred embodiments, in the region of such a protrusion, also has an increased bead height and therefore a greater rigidity or a greater deformation resistance compared with longitudinal regions of the intermediate portions without such a protrusion, but with identical bead width as compared to a longitudinal region provided with such a protrusion (the bead width shall be understood here to mean the width of the combustion-chamber sealing bead in a plan view of the concave side thereof).

Above, it has been described what shall be understood, for the present invention, by the height of the bead legs of the combustion-chamber sealing bead according to the invention. What will now be described hereinafter is what shall be understood, for the invention, by the width of the bead legs of a combustion-chamber sealing bead according to the invention, more specifically on the one hand in screw portions and on the other hand in intermediate portions of a combustion-chamber sealing bead according to the invention. This description is provided on the basis of a combustion-chamber sealing bead according to the invention, which is configured as a rectangular bead, at least in its screw portions, whereas in the intermediate portions, at least in the longitudinal regions thereof configured in accordance with the invention, the cross-section of the combustion-chamber sealing bead, on account of the forming processes performed in these longitudinal regions, differs somewhat from a rectangular bead, more specifically in respect of the cross-sectional shape of the channel arranged on the concave side of the combustion-chamber sealing bead.

In a cross-section through the combustion-chamber sealing bead, this has a center line (c), which extends perpendicularly to the plane defined by the sealing layer. In this cross-section, each of the two bead legs is delimited on its side facing the center line by a virtual line (inner line), which runs parallel to the center line, and on its other side facing away from the center line the bead leg is delimited likewise by a virtual line (outer line), which runs parallel to the center line. In this cross-section through the combustion-chamber sealing bead, the outer line runs through an outer lateral delimitation of the protrusion by which the convex side of the combustion-chamber sealing bead protrudes beyond the regions of the sealing layer directly adjacent to said combustion-chamber sealing bead.

The inner line lies between the center line and the outer line.

The above is true both for screw portions and for intermediate portions.

In a cross-section through a screw portion of the combustion-chamber sealing bead, the inner line runs through a lateral delimitation of the channel or groove stamped into the sealing layer on the concave side of the combustion-chamber sealing bead.

In a cross-section through an intermediate portion, in particular through a longitudinal region of the intermediate portion configured in accordance with the invention, the channel stamped into the sealing layer on the concave side of the combustion-chamber sealing bead has a first region, which borders the side of the sealing layer facing away from the convex side of the combustion-chamber sealing bead and has its greatest width on this sealing layer side. In this cross-section, the channel additionally has a second region, which adjoins the first region, more specifically in the direction of the convex side of the combustion-chamber sealing bead, and (again in this cross-section) has its greatest width at its transition into the first region. In an intermediate portion, this second region thus leads to an additional recess of the aforementioned channel; however, it should not be ruled out that, in a cross-section through an intermediate portion, in particular through a longitudinal region of the intermediate portion configured in accordance with the invention, at least one third region of the aforementioned channel also adjoins in the direction of the convex side of the combustion-chamber sealing bead, as a result of which the channel is made even deeper.

In such a cross-section through an intermediate portion, in particular through a longitudinal region of the intermediate portion configured in accordance with the invention, the above-mentioned inner line runs through an outer lateral delimitation of the aforementioned second region, specifically through a point at which (again in this cross-section) this second region transitions into the aforementioned first region of the channel.

In FIG. 4, in the embodiment shown there, each of the two bead legs 32a′ is delimited by an outer line a′ and by an inner line b′, wherein the aforementioned channel has been denoted on the whole by 36′, the aforementioned first channel region is formed by the groove 34a″, and the aforementioned second channel region is formed by the recess 36″.

In FIG. 3, for the embodiment shown there, the aforementioned first lines were denoted by a and the aforementioned second lines were denoted by b.

In a cross-section through a screw portion or an intermediate portion, in particular through a longitudinal region of such a portion configured in accordance with the invention, the width of each of the two bead legs is equal to the spacing of an aforementioned outer line from the aforementioned inner line adjacent thereto.

In the embodiment of the combustion-chamber sealing bead according to the invention shown in FIGS. 3 and 4, in a cross-section through a screw portion (FIG. 3), the width of each bead leg 32a is equal to the spacing of an outer line a from the inner line b adjacent thereto, and, in a cross-section through an intermediate portion (FIG. 4), the width of each bead leg 32a′ is equal to the spacing of an outer line a′ from the inner line b′ adjacent thereto.

The same is true for a combustion-chamber sealing bead according to the invention configured as a trapezoidal bead, wherein, however, it must be taken into consideration that, in the case of a trapezoidal bead, the two bead legs do not run perpendicularly, but at an incline to the plane of the sealing layer, more specifically both in a cross-section through a screw portion and in a cross-section through an intermediate portion of the combustion-chamber sealing bead—the aforementioned outer and inner lines then run likewise parallel to one another, but also at an incline to the plane of the sealing layer.

Since the increase in some regions of the deformation resistance of the bead legs is preferably achieved in that, as the combustion-chamber sealing bead is stamped, the sheet steel used for the production of the sealing layer is deformed to differing extents in some regions, more specifically primarily or predominantly in order to form the bead legs, a steel which can be formed more easily, that is to say with lower forces, than spring steels is preferably used for the production of the sealing layer; apart from any coatings, preferred embodiments of the sealing layer are thus characterized in that the sealing layer is one produced from a soft steel for cold forming, that is to say the steel is a cold-formable and thus strain-hardenable steel. Beyond formed regions of the sealing layer, the sheet steel thereof thus consists of a steel which is cold-formable to the same extent as the steel of the sheet steel used for the production of the sealing layer.

For the production of preferred embodiments of the sealing layer, recommended are steels for which the properties determining the cold forming are at least approximately the same as the cold-forming-determining properties of the steel having material number 1.0338 (in particular according to standard DIN EN 10130:1991), wherein the steel with the material number 1.0338 is particularly preferred.

When stamping preferred embodiments of the combustion-chamber sealing bead according to the invention, the sheet steel used for the production of the sealing layer is deformed to such an extent that the degree of deformation of the steel in the region of an intermediate portion, in particular a longitudinal region of the intermediate portion configured in accordance with the invention, of the combustion-chamber sealing bead, specifically in particular in the region of the bead legs, is at least 5% (in forming technology the degree of deformation is usually denoted by 1). The maximum of the degree of deformation is particularly preferably much more than 5%. In the embodiment shown in FIG. 4 the maximum degree of deformation in the region of an intermediate portion, in particular a longitudinal region of the intermediate portion configured in accordance with the invention, is at least substantially equal to the ratio E′:E.

In preferred embodiments of the combustion-chamber sealing bead according to the invention, as an intermediate portion of the combustion-chamber sealing bead is stamped, in particular a longitudinal region of the intermediate portion configured in accordance with the invention, the channel stamped into the concave side of the combustion-chamber sealing bead is made additionally deeper (in comparison to the channel of a screw portion), wherein, in a cross-section through the longitudinal region of the intermediate portion configured in accordance with the invention, the additional recess has a smaller width than the channel width on the side of the sealing layer facing away from the convex side of the combustion-chamber sealing bead. In the region of the additional recess, the material thickness of the crest portion of the combustion-chamber sealing bead is reduced in some regions (in comparison with the thickness of the crest portion in a screw region of the combustion-chamber sealing bead).

In preferred embodiments of the combustion-chamber sealing bead according to the invention, the channel stamped in the concave side of said bead is constructed, in a cross-section through the combustion-chamber sealing bead, at least substantially symmetrically with respect to a line which runs perpendicularly to the sealing layer plane and which is the aforementioned center line.

In the case of the combustion-chamber sealing bead according to the invention, this forms a land on its convex side, which land protrudes (or projects) beyond the regions of the sealing layer directly adjacent to the combustion-chamber sealing bead. In preferred embodiments of the sealing layer the width of the land, as measured in a plan view of the sealing layer or land thereof, along the combustion-chamber sealing bead, is at least substantially constant—in the embodiment shown in FIGS. 3 and 4 the dimension C′ from FIG. 4 is thus at least substantially the same as the dimension C from FIG. 3.

In addition, it should also be noted in respect of FIGS. 3 and 4 that the dimension E from FIG. 3 should be equal to the dimension E in FIG. 4, because this denotes the material thickness of the sealing layer 10 outside the combustion-chamber sealing bead, but at least in the regions of the sealing layer directly adjacent to the combustion-chamber sealing bead.

In a plan view of an intermediate portion configured in accordance with the invention or a longitudinal region of an intermediate portion configured in accordance with the invention, more specifically in a plan view of the concave side of the combustion-chamber sealing bead, the width of the stamped channel, where it transitions into the side of the sealing layer 10 facing away from the convex side of the combustion-chamber sealing bead, is at least substantially the same as the width of the channel or groove stamped into the sealing layer in a screw portion of the combustion-chamber sealing bead on the concave side thereof, and therefore, in the embodiment shown in FIGS. 3 and 4, the dimension D″ from FIG. 4 is at least substantially the same size as the dimension D from FIG. 3.

During the production of an intermediate portion, in particular a longitudinal region of the intermediate portion configured in accordance with the invention, of a combustion-chamber sealing bead according to the invention, as the channel provided on the concave side of the combustion-chamber sealing bead is being stamped (said channel being denoted by 36′ in the embodiment shown in FIG. 4), more specifically the additional recess of said channel (denoted in FIG. 4 by 36″), metal of the sealing layer is displaced in the direction of the convex side of the combustion-chamber sealing bead, but primarily transversely and at an incline to this direction, into the bead legs (denoted in FIG. 4 by 32a′) produced by the stamping of the channel, wherein the metal flows and is thus strain-hardened; the metal of the combustion-chamber sealing bead is thus strain-hardened primarily in the region of the two bead legs.

In preferred embodiments of the combustion-chamber sealing bead according to the invention, neither the width nor the height of the land formed by the convex side of the combustion-chamber sealing bead is thus changed (in comparison to this land in a screw portion of the combustion-chamber sealing bead). In the embodiment shown in FIGS. 3 and 4, the dimension C from FIG. 3 is thus at least substantially the same size as the dimension C′ from FIG. 4, and the dimensions G₁ from FIGS. 3 and 4 are likewise at least substantially the same size.

The local increase in the deformation resistance or the rigidity of the combustion-chamber sealing bead according to the invention therefore is not based, or at least is not significantly based, on a local change to the ratio of bead width to bead height, but primarily or predominantly on a local change to the cross-sectional shape and/or the structure of the bead legs.

It should again also be noted that in preferred embodiments of the cylinder-head gasket according to the invention the combustion-chamber sealing bead has, in its intermediate portions, a constant width, that is to say no width profile (in a plan view of the convex side of the combustion-chamber sealing bead).

Since a cylinder-head gasket according to the invention, in the installed state, that is to say when it is clamped between the engine components constituted by the engine block and cylinder head, is intended to generate, by means of its bead crest and its bead feet, sufficiently high pressing forces all over in order to gasket off the combustion-chamber gases, it should be ensured that each cylinder-head gasket is constructed for a quite specific engine, which is stipulated to the gasket fabricator by the engine manufacturer, who provides the gasket fabricator with the engine data necessary for construction of a seal. On the basis of this engine data, the gasket manufacturer may perform FEM (finite element method) calculations for production of a cylinder-head gasket according to the invention, with the aid of which calculations the combustion-chamber sealing bead can be readily configured such that it generates, by means of its bead crest and its bead feet, sufficiently high pressing forces all over for a sealing of the combustion-chamber gases when the cylinder-head gasket is in the installed state, more specifically also at points of the sealing assembly comprising the engine block, the cylinder head, and the cylinder-head gasket at which the installation space available for accommodating the combustion-chamber sealing bead is limited, whether the sealing face of the engine block and/or of the cylinder head facing the cylinder-head gasket has an opening in the direct vicinity of the combustion-chamber sealing bead, or whether at least one of these engine components has a local component weakness.

As can be understood on the basis of the above description and/or the accompanying drawings, the present invention may also be defined as follows, wherein the cylinder-head gasket defined hereinafter preferably also has features of the accompanying claims 1 to 31.

The invention relates to a cylinder-head gasket with a metal sealing layer in which there are provided at least one combustion-chamber opening, screw holes each defining a screw hole axis around said opening for the passage of cylinder-head screws, and a combustion-chamber sealing bead stamped into the sealing layer, wherein, in a plan view of the sealing layer, the screw holes are arranged at a spacing from the combustion-chamber opening and at spacings from one another in the peripheral direction of the combustion-chamber opening, and the combustion-chamber sealing bead runs between the combustion-chamber opening and the screw holes and has screw portions, each of which lies closest to a screw hole, and intermediate portions between the screw portions, and wherein the combustion-chamber sealing bead, on its concave side, forms a channel stamped into the sealing layer, extending in the bead longitudinal direction, and having a channel base.

In order to improve the sealing capability of a cylinder-head gasket of this kind, said gasket is configured in accordance with the invention such that, in cross-sections through the combustion-chamber sealing bead, at the channel base the material thickness of the sealing layer in intermediate portions of the combustion-chamber sealing bead, specifically at least in longitudinal regions of the intermediate portions, is smaller than in screw portions of the combustion-chamber sealing bead.

In the case of such a cylinder-head seal, as the combustion-chamber sealing bead is stamped into the sealing layer, at least in longitudinal regions of the intermediate portions, the metal of the sealing layer is cold-formed to a greater extent and is thus strain-hardened to a greater extent than in screw portions of the combustion-chamber sealing bead, which results in an increase of the deformation resistance of the combustion-chamber sealing bead with respect to these pressing forces acting in the direction of the screw hole axes in intermediate portions of the combustion-chamber sealing bead, specifically at least in longitudinal regions of the intermediate portions (in comparison to the deformation resistance of the combustion-chamber sealing bead in screw portions thereof).

Here, preferred embodiments are ones in which, in cross-sections through the combustion-chamber sealing bead, the depth of the channel in intermediate portions of the combustion-chamber sealing bead, specifically at least in longitudinal regions of the intermediate portions, is greater than in screw portions of the combustion-chamber sealing bead, and in which, in intermediate portions of the combustion-chamber sealing bead, specifically at least in longitudinal regions of the intermediate portions, the cross-sectional form of the channel differs from the cross-sectional form of the channel in screw portions. Here, the cross-sectional form of the channel is understood to mean the geometrical shape of the cross-sectional form, and for example not the size of the dimensions of the cross-sectional form.

Among these preferred embodiments, particularly advantageous are those in which, in cross-sections through the combustion-chamber sealing bead, the cross-sectional area of the channel in the intermediate portions of the combustion-chamber sealing bead, specifically at least in longitudinal regions of the intermediate portions, is greater than in screw portions of the combustion-chamber sealing bead, and it is even more advantageous if, in cross-sections through the combustion-chamber sealing bead, the width of the channel decreases in the direction of the channel base, more specifically at least in intermediate portions of the combustion-chamber sealing bead, which means that, in cross-sections through the combustion-chamber sealing bead, the width of the channel in the direction of the channel base in screw portions of the combustion-chamber sealing bead may also be constant.

It is most advantageous if the percentage decrease of the width of the channel in the direction of the channel base in intermediate portions of the combustion-chamber sealing bead, specifically at least in longitudinal regions of the intermediate portions, is greater than in screw portions, this being important in the case of combustion-chamber sealing beads in the form of a trapezoidal bead.

1. A cylinder-head gasket comprising a metal sealing layer in which there are provided at least one combustion-chamber opening, screw holes each defining a screw hole axis around said opening for the passage of cylinder-head screws, and a combustion-chamber sealing bead stamped into the sealing layer, wherein the combustion-chamber sealing bead has, on its convex side, a crest portion which extends in the bead longitudinal direction and is arranged along the combustion-chamber sealing bead in a plan view of the sealing layer between two bead legs, by means of which bead legs the crest portion is connected to regions of the sealing layer bordering the combustion-chamber sealing bead, into which regions the bead legs transition in each case by a bead foot, and wherein in a plan view of the sealing layer the screw holes are arranged at a spacing from the combustion-chamber opening and at spacings from one another in the peripheral direction of the combustion-chamber opening and the combustion-chamber sealing bead runs between the combustion-chamber opening and the screw holes and has screw portions, each of which lies closest to a screw hole, and intermediate portions between these screw portions,
wherein the deformation resistance of the bead legs with respect to pressing forces acting on the crest portion in the direction of the screw hole axes is greater at least in longitudinal regions of the intermediate portions of the combustion-chamber sealing bead than in screw portions of the combustion-chamber sealing bead.

2. The cylinder-head gasket in accordance with claim 1, wherein, in intermediate portions along the combustion-chamber sealing bead at least in longitudinal regions of the intermediate portions,
(a) the cross-section of the bead legs in its cross-sectional shape and/or cross-sectional area
and/or
(b) the hardness or compressive strength of the metal of the bead legs, averaged over the cross-section of the bead legs,
varies such that, in these longitudinal regions of the intermediate portions, the deformation resistance of the combustion-chamber sealing bead measured in the direction of the screw hole axes differs locally along the combustion-chamber sealing bead.

3. The cylinder-head gasket in accordance with claim 1, wherein along the combustion-chamber sealing bead in zones of the bead legs delimited by planes running parallel to the plane of the sealing layer, at least in longitudinal regions of the intermediate portions, the material thickness and/or the structure of the metal of the bead legs varies such that, along the combustion-chamber sealing bead in these longitudinal regions of the intermediate portions, the deformation resistance of the combustion-chamber sealing bead measured in the direction of the screw hole axes is different locally along the combustion-chamber sealing bead.

4. The cylinder-head gasket in accordance with claim 1, wherein, along the combustion-chamber sealing bead, the cross-section of said bead and/or the structure of the metal of the sealing layer varies in such a way that when the cylinder-head gasket is installed and pressed between engine components, the crest portion of the combustion-chamber sealing bead is acted on all over, in the intermediate portions of said bead, by pressing forces sufficient to provide an adequate sealing of combustion-chamber gases.

5. The cylinder-head gasket in accordance with claim 1, wherein, at least in longitudinal regions of the intermediate portions in cross-sections through the intermediate portions, the material thickness of the bead legs and/or the structure of the metal of the bead legs varies
(a) along these longitudinal regions of the intermediate portions
and/or
(b) at least in some of these cross-sections along the bead legs,
such that the deformation resistance of the combustion-chamber sealing bead, measured in the direction of the screw hole axes, is locally different along the combustion-chamber sealing bead, at least in these longitudinal regions of the intermediate portions.

6. The cylinder-head gasket in accordance with claim 1, wherein, along the combustion-chamber sealing bead, the cross-section of the combustion-chamber sealing bead and/or the structure of the metal of the sealing layer varies at least substantially in the two sealing legs.

7. The cylinder-head gasket in accordance with claim 1, wherein, along the combustion-chamber sealing bead at least in longitudinal regions of the intermediate portions of the combustion-chamber sealing bead, the crest portion of the combustion-chamber sealing bead is provided with at least one stamped protrusion extending in the longitudinal direction of the combustion-chamber sealing bead.

8. The cylinder-head gasket in accordance with claim 7, wherein the protrusion projects in the direction pointing away from the bead feet.

9. The cylinder-head gasket in accordance with claim 1, wherein the combustion-chamber sealing bead, on its concave side, forms a channel extending in the bead longitudinal direction and having a channel base, and wherein, in cross-sections through the combustion-chamber sealing bead, at least the channel thereof is formed at least substantially mirror-symmetrically with respect to a line running perpendicularly to the sealing layer plane.

10. The cylinder-head gasket in accordance with claim 1, wherein the width of the crest portion of the combustion-chamber sealing bead, measured on the convex side of the combustion-chamber sealing bead in a plan view of the sealing layer, is at least substantially constant along the combustion-chamber sealing bead.

11. The cylinder-head gasket in accordance with claim 1, wherein, along the entire combustion-chamber sealing bead, the height of the bead legs measured perpendicularly to the plane of the sealing layer is at least substantially constant.

12. The cylinder-head gasket in accordance with claim 1, wherein, along the entire combustion-chamber sealing bead, the crest portion on the convex side of the combustion-chamber sealing bead forms at least one support face, which extends along the combustion-chamber sealing bead and runs at least approximately parallel to the sealing layer plane.

13. The cylinder-head gasket in accordance with claim 1, wherein, along the entire combustion-chamber sealing bead, the longitudinal direction of each bead leg arising in cross-sections through the combustion chamber sealing bead forms an angle with the perpendicular to the sealing layer plane, the size of which angle is at least approximately 0° or at least approximately 5° to at least approximately 45°.

14. The cylinder-head gasket in accordance with one of claim 1, wherein, along the entire combustion-chamber sealing bead, in cross-sections therethrough, the combustion chamber sealing bead, on its convex side, forms a land portion with an outer contour, the portions of which facing away from one another form an angle with the perpendicular to the sealing layer plane, the size of which angle is at least approximately 0° to at least approximately 5° or at least approximately 10° to at least approximately 45°.

15. The cylinder-head gasket in accordance with claim 1, wherein the combustion-chamber sealing bead, on its concave side, forms a channel extending in the bead longitudinal direction, wherein, in cross-sections through intermediate portions of the combustion-chamber sealing bead, at least through longitudinal regions of the intermediate portions, the channel has a contour with contour portions facing away from one another in relation to a perpendicular to the sealing layer plane, and wherein a tangent to each of these contour portions forms an angle with a perpendicular to the sealing layer plane, the size of which angle is at least approximately 10° to at least approximately 50° or at least approximately 20° to at least approximately 60°.

16. The cylinder-head gasket in accordance with claim 1, wherein the metal sealing layer is a sheet steel made of a steel which, in unformed regions of the sealing layer, in particular in regions of the sealing layer directly bordering the combustion-chamber sealing bead, is more ductile, namely is more easily formable, than spring steels.

17. The cylinder-head gasket in accordance with claim 16, wherein the steel in unformed regions of the sealing layer is a cold-formable and strain-hardenable steel.

18. The cylinder-head gasket in accordance with claim 16, wherein the steel is strain-hardened at least in regions of the combustion-chamber sealing bead in comparison to the steel in unformed regions.

19. The cylinder-head gasket in accordance with claim 18, wherein the steel is strain-hardened to the greatest extent at least in regions of the bead legs.

20. The cylinder-head gasket in accordance with claim 16, wherein the properties determining the formability of the steel used for production of the sealing layer are substantially the same as the formability-determining properties of a steel having material number 1.0338.

21. The cylinder-head gasket in accordance with claim 1, wherein the combustion-chamber sealing bead, on its concave side, forms a channel extending in the bead longitudinal direction, wherein, in cross-sections through intermediate portions of the combustion-chamber sealing bead, at least through longitudinal regions of the intermediate portions, the channel, as compared with the channel in cross-sections through screw portions of the combustion-chamber sealing bead, has an additional recess extending in the direction of the convex side of the combustion-chamber sealing bead.

22. The cylinder-head gasket in accordance with claim 21, wherein the channel inclusive of its additional recess, in cross-sections through the combustion-chamber sealing bead, is at least substantially mirror-symmetrical with respect to a line running perpendicularly to the sealing layer plane.

23. The cylinder-head gasket in accordance with claim 21, wherein, in cross-sections through the combustion-chamber sealing bead, the greatest width of the additional recess is smaller than the width of the channel at the transition thereof into the side of the sealing layer facing away from the convex side of the combustion-chamber sealing bead.

24. The cylinder-head gasket in accordance with claim 1, wherein the combustion-chamber sealing bead, on its concave side, forms a channel extending in the bead longitudinal direction, stamped into the metal sealing layer, and having a channel base at its deepest point in cross-sections through the combustion-chamber sealing bead, and wherein, in cross-sections through the combustion-chamber sealing bead, the material thickness of the combustion-chamber sealing bead in the region of the channel base in intermediate portions of the combustion-chamber sealing bead is smaller, at least in longitudinal regions of the intermediate portions, than in screw portions of the combustion-chamber sealing bead.

25. The cylinder-head gasket in accordance with claim 24, wherein, as a result of the stamping of the channel, the metal of the sealing layer in the region of the channel base is formed in first longitudinal regions of the intermediate portions of the combustion-chamber sealing bead with a forming degree Φ1, and outside these first longitudinal regions with a forming degree Φ₂, wherein Φ₁ is greater than Φ₂.

26. The cylinder-head gasket in accordance with claim 21, wherein the channel has an additional recess in the first longitudinal regions of the intermediate portions.

27. A cylinder-head gasket comprising a metal sealing layer, in which there are provided at least one combustion-chamber opening, screw holes each defining a screw hole axis around said opening for the passage of cylinder-head screws, and a combustion-chamber sealing bead stamped into the sealing layer, wherein in a plan view of the sealing layer the screw holes are spaced from the combustion-chamber opening and are arranged at spacings from one another in the peripheral direction of the combustion-chamber opening, and the combustion-chamber sealing bead runs between the combustion-chamber opening and the screw holes and has screw portions, each of which lies closest to a screw hole, and between the screw portions has intermediate portions, wherein the combustion-chamber sealing bead, on its concave side, forms a channel, which extends in the bead longitudinal direction, is stamped into the sealing layer, and has a channel base, and wherein, in cross-sections through the combustion-chamber sealing bead at the channel base the material thickness of the sealing layer in intermediate portions of the combustion-chamber sealing bead, specifically at least in longitudinal regions of the intermediate portions, is smaller than in screw portions of the combustion-chamber sealing bead.

28. The cylinder-head gasket in accordance with claim 27, wherein, in cross-sections through the combustion-chamber sealing bead, the depth of the channel in intermediate portions of the combustion-chamber sealing bead, specifically at least in longitudinal regions of the intermediate portions, is greater than in screw portions of the combustion-chamber sealing bead, and wherein, in intermediate portions of the combustion-chamber sealing bead, specifically at least in longitudinal regions of the intermediate portions, the cross-sectional shape of the channel deviates from the cross-sectional shape of the channel in screw portions.

29. The cylinder-head gasket in accordance with claim 28, wherein, in cross-sections through the combustion-chamber sealing bead, the cross-sectional area of the channel in intermediate portions, specifically at least in longitudinal regions of the intermediate portions, is greater than in screw portions.

30. The cylinder-head gasket in accordance with claim 29, wherein, in cross-sections through the combustion-chamber sealing bead, the width of the channel decreases in the direction toward the channel base, more specifically at least in intermediate portions of the combustion-chamber sealing bead.

31. The cylinder-head gasket in accordance with claim 30, wherein, in cross-sections through the combustion-chamber sealing bead, the degree of the decrease in the width of the channel in the direction toward the channel base in intermediate portions, specifically at least in longitudinal regions of the intermediate portions, is greater than in screw portions.

32. A method for producing a cylinder-head gasket with a metal sealing layer in which there are provided at least one combustion-chamber opening, screw holes each defining a screw hole axis around said opening for the passage of cylinder-head screws, and a combustion-chamber sealing bead stamped into the sealing layer, wherein the combustion-chamber sealing bead has, on its convex side, a crest portion which extends in the bead longitudinal direction and is arranged along the combustion-chamber sealing bead in a plan view of the sealing layer between two bead legs, by means of which bead legs the crest portion is connected to regions of the sealing layer bordering the combustion-chamber sealing bead, into which regions the bead legs transition in each case by a bead foot, and wherein in a plan view of the sealing layer the screw holes are spaced from the combustion-chamber opening and are arranged at spacings from one another in the peripheral direction of the combustion-chamber opening and the combustion-chamber sealing bead runs between the combustion-chamber opening and the screw holes and has screw portions, each of which lies closest to a screw hole, and intermediate portions between the screw portions, wherein, in order to attain local increases in the deformation resistance of intermediate portions of the combustion-chamber sealing bead with respect to pressing forces acting on the crest portion of said bead in the direction of the screw hole axes when stamping intermediate portions, bead legs are produced at least in longitudinal regions of the intermediate portions, with the cross-section of said bead legs varying in its shape and/or area and/or structure
(a) along these longitudinal regions of the intermediate portions
and/or
(b) along the bead legs in cross-sections therethrough in at least part of these cross-sections,
such that the deformation resistance of each of the bead legs, measured in the direction of the screw hole axes, is locally different along the combustion-chamber sealing bead at least in these longitudinal regions of the intermediate portions.

33. The method in accordance with claim 32, wherein, as the combustion-chamber sealing bead is stamped into the sealing layer, a basic bead with an at least substantially constant cross-section along the basic bead and with screw portions, each arranged closest to a screw hole, and intermediate portions situated between said screw portions is firstly stamped into the sealing layer, whereupon at least longitudinal regions of these intermediate portions of the basic bead are then formed by stamping, at least such that there are produced the bead legs of the combustion-chamber sealing bead that vary in their cross-section and/or their structure.

34. The method in accordance with claim 32, wherein, as the intermediate portions of the combustion-chamber sealing bead are stamped, at least in longitudinal regions of the intermediate portions of the combustion-chamber sealing bead, the metal of the sealing layer is strain-hardened locally by yield pressure forming.

35. The method in accordance with claim 32, wherein, along the combustion-chamber sealing bead at least in longitudinal regions of the intermediate portions of the combustion-chamber sealing bead, the crest portion of said bead is provided by stamping with at least one protrusion extending in the longitudinal direction of the combustion-chamber sealing bead.

36. The method in accordance with claim 34, wherein, as the region of the crest portion provided with the protrusion is stamped, metal of the sealing layer is displaced into the bead legs by yield pressure forming.

37. A cylinder-head gasket produced by a method in accordance with claim 32.

38. A multi-cylinder reciprocating internal combustion engine with an engine block, a cylinder head, and a cylinder-head seal, which is clamped and pressed by means of cylinder-head screws between component sealing faces of the engine block and cylinder head and has a metal sealing layer, in which there are provided a combustion-chamber opening for each cylinder of the engine, screw holes around said opening for the passage of cylinder-head screws, and a combustion-chamber sealing bead stamped into the sealing layer, wherein the combustion-chamber sealing bead on its convex side has a crest portion extending in the bead longitudinal direction, which crest portion is arranged along the combustion-chamber sealing bead, in a plan view of the sealing layer between two bead legs, by means of which bead legs the crest portion is connected to regions of the sealing layer bordering the combustion-chamber sealing bead, into which regions the bead legs transition in each case by means of a bead foot, and wherein, in a plan view of the sealing layer, the screw holes are spaced from the combustion-chamber opening and are arranged at spacings from one another in the peripheral direction of the combustion-chamber opening, and the combustion-chamber sealing bead runs between the combustion-chamber opening and the screw holes and has screw portions, each of which lies closest to a screw hole, and between the screw portions has intermediate portions, and wherein at least one of the components constituted by the engine block and cylinder head has, in its component sealing face, at least one sealing face region, in which the component rigidity of this component with respect to pressing forces directed perpendicularly to its component sealing face is lower than in sealing face regions of this component adjacent to this sealing face region, wherein the deformation resistance of the bead legs with respect to pressing forces oriented perpendicularly to the sealing layer and acting on the crest portion is greater, at least in longitudinal regions of the intermediate portions of the combustion-chamber sealing bead, than in screw portions of the combustion-chamber sealing bead, and wherein, along at least one intermediate portion of the combustion-chamber sealing bead of the clamped cylinder-head seal, the deformation resistance of the bead legs is adapted at least to the locally different component rigidity of the at least one component constituted by the engine block or cylinder head in the region of its component sealing face pressed against the intermediate portion of the combustion-chamber sealing bead, in such a way that sealing face regions of lower component rigidity are associated with bead leg regions of greater deformation resistance.

39. The internal combustion engine in accordance with claim 38, the engine block of which has, for each cylinder, a cylinder liner with a liner sealing face facing the cylinder-head seal and cooperating therewith, with a liner sealing face region surrounding the axis of the cylinder liner, against which linear sealing face region the combustion-chamber sealing bead of the cylinder-head seal is pressed, wherein the combustion-chamber sealing bead abuts with its crest portion against this liner sealing face region.

40. The internal combustion engine in accordance with claim 39, wherein the cylinder liner has, at its outer periphery, an annular flange, by means of which the cylinder liner is supported in the direction of its axis in the engine block, and wherein, in a plan view of the cylinder-head seal, the crest portion of the combustion-chamber sealing bead lies over the flange of the cylinder liner.

41. The internal combustion engine in accordance with claim 40, wherein the flange of the cylinder liner forms the liner sealing face.

42. An internal combustion engine in accordance with claim 38, with a cylinder-head seal that comprises a cylinder-head gasket comprising a metal sealing layer in which there are provided at least one combustion-chamber opening, screw holes each defining a screw hole axis around said opening for the passage of cylinder-head screws, and a combustion-chamber sealing bead stamped into the sealing layer, wherein the combustion-chamber sealing bead has, on its convex side, a crest portion which extends in the bead longitudinal direction and is arranged along the combustion-chamber sealing bead in a plan view of the sealing layer between two bead legs, by means of which bead legs the crest portion is connected to regions of the sealing layer bordering the combustion-chamber sealing bead, into which regions the bead legs transition in each case by a bead foot, and wherein in a plan view of the sealing layer the screw holes are arranged at a spacing from the combustion-chamber opening and at spacings from one another in the peripheral direction of the combustion-chamber opening and the combustion-chamber sealing bead runs between the combustion-chamber opening and the screw holes and has screw portions, each of which lies closest to a screw hole, and intermediate portions between these screw portions,
wherein the deformation resistance of the bead legs with respect to pressing forces acting on the crest portion in the direction of the screw hole axes is greater at least in longitudinal regions of the intermediate portions of the combustion-chamber sealing bead than in screw portions of the combustion-chamber sealing bead.
